(19) United States
(12) Patent Application Publication
(10) Pub. No.: US 2021/0139711 A1
(43) Pub. Date: May 13, 2021

(54) THERMOFORMABLE AND SCRATCH-RESISTANT PHOTOPOLYMER COATINGS

(71) Applicants: UNIVERSITÉ DE HAUTE-ALSACE, MULHOUSE (FR); A ET A MADER, Lille (FR); ARKEMA FRANCE, COLOMBES (FR)

(72) Inventors: Céline CROUTXÉ-BARGHORN, RANTZWILLER (FR); Bandar EL FOUAHILI, BRIGNAIS (FR); Bruno ANDRÉ, ANGERS (FR); Adrien CRIQUI, UNGERSHEIM (FR); Henri PLANEIX, AVRILLÉ (FR); Catherine LEROY, LILLE (FR)

(21) Appl. No.: 16/341,165

(22) PCT Filed: Oct. 11, 2017
(86) PCT No.: PCT/FR2017/052796

§ 371 Date: Jan. 13, 2021

(30) Foreign Application Priority Data
Oct. 11, 2016 (FR) 1659789

(51) Int. Cl. C09D 4/00; C09D 175/16; C09D 7/20; C09D 7/48; C08F 136/02; C08F 136/22; C08F 2/50; C08K 5/00; C08K 5/5419; C08K 5/544; C08K 5/54; C08G 18/62; C08G 18/72

(52) U.S. Cl. CPC C09D 4/00; C09D 175/16; C09D 7/20; C09D 7/48; C08F 136/02; C08F 136/22; C08G 18/72; C08K 5/0025; C08K 5/005; C08K 5/5419; C08K 5/544; C08K 5/5406; C08G 18/6225; C08F 2/50

(57) ABSTRACT

The present invention relates, in particular, to a coating composition, cross-linkable under the action of UV-visible radiation, which has the advantage of being thermoformable and having excellent scratch and abrasion resistant properties. The present invention also relates to a method for preparing a thermoformable coating, resistant to scratches and abrasion, comprising the cross-linking of a composition according to the invention under the action of UV-visible radiation. The present invention also relates to a method for protecting a substrate against scratches and abrasion, preferably said substrate being thermoformable or thermodrapable. The present invention also relates to a coated article, resistant to scratches and abrasion, preferably a thermoformable or thermodrapable coated article that can be obtained by a method according to the invention, as well as the use of a composition according to the invention to protect a possibly thermoformable or thermodrapable substrate against scratches and abrasion. The present invention also relates to the use of a composition according to the invention for preparing thermoformable coatings, resistant to scratches and abrasion. The present invention further relates to a thermoformable coating, resistant to scratches and abrasion, characterised in that it results from cross-linking under the action of UV-visible radiation at least one composition according to the invention.

### TECHNICAL FIELD

The present invention relates especially to a varnish composition, crosslinkable under the action of UV-visible radiation, which has the advantage of being thermoformable and of having excellent scratch resistance and abrasion resistance properties.

The present invention also relates to a process for preparing a scratch-resistant and abrasion-resistant thermoformable varnish, comprising the crosslinking of a composition according to the invention under the action of UV-visible radiation.

The present invention also relates to a process for protecting a support from scratches and abrasion, said support preferably being thermoformable or thermally drape-formable.

The present invention also relates to a scratch-resistant and abrasion-resistant varnished article, preferably a thermoformable or thermally drape-formable varnished article, able to be obtained by a process according to the invention, and also the use of a composition according to the invention for protecting an optionally thermoformable or thermally drape-formable support from scratches and abrasion.

The present invention also relates to the use of a composition according to the invention for preparing scratch-resistant and abrasion-resistant thermoformable varnishes.

The present invention also relates to a scratch-resistant and abrasion-resistant thermoformable varnish, characterized in that it results from the crosslinking, under the action of UV-visible radiation, of at least one composition according to the invention.

In the description below, the references between square brackets [ ] refer to the list of references presented at the end of the text.

### PRIOR ART

Scratch-resistant coatings for polymers are known per se. However, a major drawback of the existing coating compositions is that the coatings produced from these compositions form cracks on the molded plastic parts during the hot forming, and the coating on the thermoformed article takes on a milky cloudiness and loses its esthetic quality.

Nonetheless, the subsequent thermoforming of the plastic sheets previously protected (e.g. covered with a layer of protective varnish) is desirable for a variety of reasons. For example, the transport costs of (flat) plastic sheets are significantly lower than those of thermoformed articles, especially due to the possibility of optimal stacking.

Another factor to be considered is that the production of coated sheets, and the use thereof, for example as a construction component in a motor vehicle, are carried out by different companies. Consequently, the coated construction sheets may be produced for much broader distribution networks than preformed sheets produced specifically for one customer.

In addition, numerous particularly advantageous coating techniques, such as techniques using a roll, for example, are difficult, if not impossible, to carry out on formed components.

To date, there is no satisfactory solution for protecting plastic sheets which are intended to be thermoformed from scratches and abrasion. This is because the existing solutions are either based on varnishes that dry thermally, or non-thermoformable varnishes, i.e. varnishes that contain an inorganic component (hence entailing higher costs).

There is therefore a real need to have improved compositions and processes that enable the use of scratch-resistant and abrasion-resistant protective varnishes simply using UV-visible irradiation, having good adhesion to the plastic supports, and having the property of being thermoformable; most particularly, scratch-resistant and abrasion-resistant protective varnishes that may also be used in the absence of solvent, by a quick reaction at room temperature.

### DESCRIPTION OF CERTAIN ADVANTAGEOUS EMBODIMENTS OF THE INVENTION

The aim of the present invention is precisely to respond to these needs and drawbacks of the prior art by providing a composition that is crosslinkable under UV-visible radiation at room temperature and which leads to a thermoformable/thermally drape-formable photocrosslinkable varnish which is scratch-resistant and abrasion-resistant and has excellent adhesion, especially to plastic substrates.

The key to the present invention is based on the particular selection of certain varnish components, reconciling good adhesion along with scratch resistance and abrasion resistance and thermoformability properties, which is particularly tricky. In order to achieve the former properties, it is generally necessary to turn to polymers having a high glass transition temperature and a relatively low tan 6. In order to obtain a thermodeformable material, a relatively low crosslinking density is necessary.

Thus, according to one aspect, the invention relates to a varnish composition, crosslinkable under UV-visible radiation, which makes it possible to achieve this compromise of scratch resistance/thermoformability.

In particular, the invention relates to a varnish composition, crosslinkable under the action of UV-visible radiation, comprising:
A) at least one multifunctional urethane acrylate oligomer comprising 2 to 9 acrylate functions;
B) at least one reactive diluent selected from acrylate monomers; and
C) at least one photoinitiator suitable for the light source used for the crosslinking;
D) optionally at least one surface agent; and
E) optionally at least one stabilizing anti-UV agent.

### Definitions

In order to facilitate understanding of the invention, a certain number of terms and expressions are defined below:

Generally speaking, the term “substituted”, whether or not preceded by the term “optionally”, and the substituents described in the formulae of the present document, denote the replacement of a hydrogen radical in a given structure with the radical of a specified substituent. The term “substituted” denotes for example the replacement of a hydrogen radical in a given structure by a radical R. When more than one position may be substituted, the substituents may be the same or different at each position.

The term “aliphatic”, for the purposes of the present invention, includes saturated and unsaturated hydrocarbons having a linear (i.e. non-branched) or branched, cyclic or acyclic chain, excluding aromatic groups. The term “aliphatic” includes, without being limited thereto, alkyl, alkenyl and alkynyl groups. Illustrative aliphatic groups therefore include, without being limited thereto, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, alkenyl groups such as ethenyl, propenyl, 1-methyl-2-buten-1-yl, and alkynyl groups such as ethynyl, 2-propynyl (propargyl) and 1-propynyl.

The term “alicyclic”, for the purposes of the present invention, refers to compounds which combine the properties of aliphatic and cyclic compounds and includes, without being limited thereto, cyclic or bridged polycyclic aliphatic hydrocarbons and cycloalkyl compounds which are optionally substituted by one or more functional groups. The term “alicyclic” includes, without being limited thereto, cycloalkyl, cycloalkenyl and cycloalkynyl groups, optionally substituted by one or more functional groups. Examples of alicyclic compounds therefore include, without being limited thereto, for example, cyclopropyl, —CH₂-cyclopropyl, cyclobutyl, —CH₂-cyclobutyl, cyclopentyl, —CH₂-cyclopentyl, cyclohexyl, —CH₂-cyclohexyl, cyclohexenylethyl, cyclohexanylethyl, norbornyl radicals and the like which again may bear one or more substituents.

For the purposes of the present invention, “alkyl” is intended to mean a linear, branched, cyclic or acyclic carbon-based radical, optionally substituted, comprising 1 to 25 carbon atoms, for example 1 to 10 carbon atoms, for example 1 to 8 carbon atoms, for example 1 to 6 carbon atoms. For example, the alkyl groups include, without being limited thereto, methyl, ethyl, n-propyl, isopropyl, n-butyl, sec-butyl, isobutyl, tert-butyl, n-pentyl, sec-pentyl, isopentyl, tert-pentyl, n-hexyl, sec-hexyl, etc.

For the purposes of the present invention, “haloalkyl” is intended to mean an alkyl radical as defined above, substituted by at least one halogen atom. For example, haloalkyl groups include, without being limited thereto, chloromethyl, bromomethyl, trifluoromethyl, etc.

The term “cycloalkyl”, for the purposes of the present invention, specifically refers to cyclic alkyl groups having three to seven, preferably three to ten carbon atoms. Cycloalkyl groups include, without being limited thereto, cyclopropyl, cyclobutyl, cyclopentyl, cyclohexyl, cycloheptyl and the like, which may optionally be substituted. An analogous convention applies to other generic terms such as “cycloalkenyl” and “cycloalkynyl”.

For the purposes of the present invention, “aryl” is intended to mean an aromatic system comprising at least one ring and complying with Hackers aromaticity rule. Said aryl is optionally substituted and may comprise from 6 to 50 carbon atoms, for example 6 to 20 carbon atoms, for example 6 to 10 carbon atoms. Mention may be made, for example, of phenyl, indanyl, indenyl, naphthyl, phenanthryl and anthracyl.

For the purposes of the present invention, “heteroaryl” is intended to mean a system comprising at least one 5- to 50-membered aromatic ring, among which at least one member of the aromatic ring is a heteroatom especially selected from the group consisting of sulfur, oxygen, nitrogen and boron. Said heteroaryl is optionally substituted and may comprise from 1 to 50 carbon atoms, preferably 1 to 20 carbon atoms, preferably 3 to 10 carbon atoms. Mention may be made, for example, of pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like. Mention may be made, for example, of pyridyl, quinolinyl, dihydroquinolinyl, isoquinolinyl, quinazolinyl, dihydroquinazolyl and tetrahydroquinazolyl.

For the purposes of the present invention, “arylalkyl” is intended to mean an aryl substituent bonded to the rest of the molecule via an alkyl radical. An analogous convention is used for “heteroarylalkyl”.

For the purposes of the present invention, “alkoxyl” is intended to mean an alkyl substituent as defined above, bonded to the rest of the molecule via an oxygen atom. Mention may be made, for example, of methoxyl, ethoxyl, etc.

The term “halogen”, for the purposes of the present invention, denotes an atom chosen from fluorine, chlorine, bromine and iodine.

For the purposes of the present invention, “independently” is intended to mean the fact that the substituents, atoms or groups to which this term refers are chosen from the list of variables independently of one another (in other words, they may be identical or different).

In the present document, “initiator” is intended to mean a chemical compound or a combination of compounds which makes it possible to trigger a polymerization reaction.

“Photoinitiator” is intended to mean an initiator which, under the action of light radiation, makes it possible to trigger a photopolymerization reaction.

When the term “thermoformable” is used to describe a photocrosslinked varnish according to the invention, it means a varnish which, when it is applied and photocrosslinked on a thermoformable or thermally drape-formable support, may be subjected to thermoforming with said support on any conventional commercially available thermoforming/thermal drape-forming apparatus or equivalent, preferably without the appearance of cracks in the varnish at the end of the thermoforming or thermal drape-forming process. In particular, this will be a film of varnish that covers all or part of the surface of a sheet of a thermoformable or thermally drape-formable support, such as a thermoformable or thermally drape-formable plastic support, preferably polycarbonate or polymethacrylate sheets, in particular polymethyl methacrylate sheets. In general, a photocrosslinked varnish according to the present invention is said to be “thermoformable” if, when the photocrosslinkable varnish composition is applied using a calibrated bar to a 5 mm-thick PMMA sheet having dimensions 300 mm×300 mm (preferably a “ShieldUp®” sheet (Arkema)) in the form of a 9 to 20 μm-thick film, and is crosslinked under UV-visible radiation in a single step at room temperature (25° C.) without addition of solvent, the crosslinked varnish thus obtained, covering the PMMA sheet, does not have any cracks when the PMMA sheet covered with varnish is subjected to the thermoforming test performed by the “2D” drape forming process according to the protocol of example 6.

### Constituent A—Urethane Acrylate Oligomer

In the context of the present invention, the term “oligomer”, when it is used to describe a multifunctional urethane acrylate oligomer, is synonymous with “prepolymer” as is conventionally used in the field of UV-visible crosslinkable resins. Typically, multifunctional urethane acrylate oligomers are prepared by reacting a diisocyanate or triisocyanate, preferably diisocyanate, compound with a hydroxylated acrylate monomer.

The hydroxylated acrylate monomer may be a random mixture resulting from the reaction of a polyol with a stoichiometric deficiency of acrylic acid. The polyol may for example comprise 1 to 6 hydroxyl functions. Consequently, the hydroxylated acrylate monomer may comprise residual hydroxyl functions (which will not have reacted with an acrylic acid unit) and one or more acrylate functions. For example, the hydroxylated acrylate monomer may comprise a mean number of residual hydroxyl functions of between 1 and 3, preferably between 1 and 2, more preferentially 1 or close to 1 (i.e. a mean number of residual hydroxyl functions of 1 to 1.2, or even 1 to 1.1, or even 1). Likewise, the hydroxylated acrylate monomer may comprise a mean number of acrylate functions of between 1 and 5. cf. scheme 1.

[chemical structure]

in which:
m represents 2 or 3, preferably 2;
n represents the mean number of acrylate functions present on the hydroxylated acrylate monomer, and is between 1 and 5, preferably between 1 and 4, preferably between 1 and 3, preferably between 1 and 2, preferably 1;
p represents the mean number of residual hydroxyl functions on the hydroxylated acrylate monomer, and is between 1 and 3, preferably between 1 and 2, more preferentially 1 or close to 1 (i.e. a mean number of residual hydroxyl functions of 1 to 1.2, or even 1 to 1.1, or even 1);
R₁ represents a linear or cyclic aliphatic group or aromatic group; and
R₂ independently represents a linear, branched or cyclic C1-C10 alkyl group, the C1-C10 alkyl chain being able to be optionally interrupted by an ester (—C(═O)O—) or ether (—O—)-function.

Advantageously, n, m and p are such that the multifunctional urethane acrylate oligomer comprises 2 to 9 acrylate functions (acrylate units).

Advantageously, m preferably represents 2 and n preferably represents 1.

Advantageously, p represents a mean number equal to 1 or close to 1 (i.e. a mean number from 1 to 1.2, or even from 1 to 1.1, or even 1), m preferably represents 2 and n preferably represents 1.

Advantageously, the hydroxylated acrylate monomer may be in stoichiometric excess relative to the diisocyanate or triisocyanate.

Depending on the mean functionality of the acrylate monomer (mono-, di-, tri-, tetra- or pentaacrylate), and when the mean number of hydroxyl functions thereof is 1 or close to 1, the urethane acrylate oligomer will have a functionality equal to double or triple the mean, depending on whether a diisocyanate or triisocyanate is used, respectively.

The most common isocyanates are TDI (toluene diisocyanate), HMDI (hexamethylene diisocyanate), IPDI (isophorone diisocyanate), MDI (methylene diphenyl diisocyanate):

[chemical structure]

However, the urethane acrylate oligomers used in the context of the invention are not limited to those obtained from these most common isocyanates.

Generally speaking, the urethane acrylate oligomers used in the context of the invention may be derived from any known diisocyanate or triisocyanate, whether aliphatic or aromatic. However, for external applications requiring good resistance to UV radiation and to aging, preference is given to aliphatic diisocyanates or triisocyanates, most particularly aliphatic diisocyanates.

Preferably, the urethane acrylate oligomers used in the context of the invention may be derived from linear or alicyclic aliphatic diisocyanates, which are generally more flexible than those derived from aromatic diisocyanates.

Among the linear aliphatic diisocyanates, mention may be made of diisocyanates of the OCN—(CH₂)ₓ—NCO type, in which x represents an integer from 1 to 10, preferably from 4 to 8. For example, this may be hexamethylene diisocyanate.

Among the alicyclic diisocyanates, mention may be made of isophorone diisocyanate, hydrogenated xylylene diisocyanate, hydrogenated tolylene diisocyanate and hydrogenated methylene diphenyl diisocyanate.

Among the hydroxylated acrylate monomers able to be used to generate the urethane acrylate oligomers according to the invention, mention may be made of 2-hydroxyethyl acrylate, 2-hydroxypropyl acrylate, 2-hydroxybutyl acrylate and 3-hydroxybutyl acrylate.

It will be noted that there are urethane acrylate oligomers prepared from diisocyanates or triisocyanates, the chain of which has been extended by a polyol (for example 1,6-hexanediol) or a polyester, polyether or polycarbonate comprising residual hydroxyl functions, before acrylation. The principle is illustrated in a simplified manner in scheme 2 below for diisocyanates. The reader will understand that the hydroxylated acrylate monomer may be a random mixture resulting from the reaction of a polyol with a stoichiometric deficiency of acrylic acid, and that the hydroxylated acrylate monomer may be in stoichiometric excess relative to the diisocyanate. The principle extends in the same manner to triisocyanates.

[chemical structure]

This type of multifunctional urethane acrylate oligomers (polyester, polyether, polycarbonate or polyol) is excluded from the context of the present invention. The multifunctional urethane acrylate oligomers considered in the present invention are those able to be obtained according to scheme 1 (i.e. without extending the urethane chain with a polyol, or a polyester, polyether or polycarbonate comprising residual hydroxyl functions).

Thus, the multifunctional urethane acrylate oligomers according to the present invention are products of the reaction of a diisocyanate or triisocyanate with a hydroxylated acrylate monomer, preferably with a stoichiometric excess of a hydroxylated acrylate monomer, said hydroxylated acrylate monomer being a random mixture resulting from the reaction of a polyol with a stoichiometric deficiency of acrylic acid, with the proviso that the chain of the diisocyanate or triisocyanate has not be extended beforehand by a polyol (for example 1,6-hexanediol) or a polyester, polyether or polycarbonate comprising residual hydroxyl functions. The multifunctional urethane acrylate oligomers according to the present invention may correspond to the following formula I:

[chemical structure]

in which:
m represents 2 or 3, preferably 2;
n represents a mean number of acrylate functions of between 1 and 5, preferably between 1 and 4, preferably between 1 and 3, preferably between 1 and 2, preferably 1;
p represents a mean number of between 1 and 3, preferably between 1 and 2, more preferentially 1 or close to 1 (i.e. a mean number of 1 to 1.2, or even 1 to 1.1, or even 1);
R₁ represents a C1 to C10 aliphatic, mono- or bicyclic C5 to C8 alicyclic or C6 to C13 aromatic radical, preferably C1 to C10 aliphatic or C5 to C8 alicyclic, optionally substituted with one or more C1-C6 alkyl radicals; and
R₂ independently represents a linear, branched or cyclic C1-C10 alkyl group, the C1-C10 alkyl chain being able to be optionally interrupted by an ester (—C(═O)O—) or ether (—O—)-function.

Advantageously, n, m and p are such that the multifunctional urethane acrylate oligomer of formula (I) comprises 2 to 9 acrylate functions (acrylate units).

Advantageously, m preferably represents 2 and n preferably represents 1.

Advantageously, p represents a mean number equal to 1 or close to 1 (i.e. a mean number from 1 to 1.2, or even from 1 to 1.1, or even 1), m preferably represents 2 and n preferably represents 1.

Preferably, the multifunctional urethane acrylate oligomers according to the present invention correspond to the following formula I^{A}:

[chemical structure]

in which R₁ and R₂ are as defined above, and each instance of n independently represents a mean number of acrylate functions of between 1 and 4, preferably between 1 and 3, preferably between 1 and 2, preferably 1. The functionality of the urethane acrylate oligomer is equal to 2n.

The multifunctional urethane acrylate oligomers according to the present invention may also correspond to the following formula I^{B}:

[chemical structure]

in which R₁ and R₂ are as defined above, and each instance of n independently represents a mean number of acrylate functions of between 1 and 3, preferably between 1 and 2, preferably 1. In this case, the functionality of the urethane acrylate oligomer is equal to 3n.

The multifunctional urethane acrylate oligomer may be chosen from multifunctional urethane acrylate oligomers of formula I as defined above, which are commercially available, for example from Sartomer and Allnex. For example, the multifunctional urethane acrylate oligomers of use in the context of the present invention may be chosen from:

| Product | | |
|---|---|---|
| reference | Chemical name | Functionality |
| CN9001 | Aliphatic urethane acrylate | Difunctional |
| CN9002 | Aliphatic urethane acrylate | Difunctional |
| CN910A70 | Aliphatic urethane acrylate | Difunctional |
| CN9165A | Aromatic urethane acrylate | Tetrafunctional |
| CN9167 | Aromatic urethane acrylate | Difunctional |
| CN9170A86 | Aromatic urethane acrylate | Difunctional |
| | diluted with 14% TPGDA | |
| | (tripropylene glycol diacrylate) | |
| CN9200 | Aliphatic urethane acrylate | Difunctional |
| CN9210 | Aliphatic urethane acrylate | Hexafunctional |
| CN9215 | Aliphatic urethane acrylate | Hexafunctional |
| CN9245S | Water-dilutable aliphatic | Trifunctional |
| | urethane acrylate | |
| CN925 | Modified aliphatic urethane | Tetrafunctional |
| | acrylate | |
| CN9250A75 | Aliphatic urethane acrylate | Trifunctional |
| | diluted with 25% TPGDA | |
| CN9260D75 | Aliphatic urethane acrylate | Trifunctional |
| | diluted with 25% GPTA | |
| | (glyceryl propoxy triacrylate) | |
| CN9276 | Aliphatic urethane acrylate | Tetrafunctional |
| CN9400 | Aliphatic urethane hexaallyl | Hexafunctional |
| CN963B80 | Aliphatic urethane acrylate | Difunctional |
| | diluted with 20% HDDA | |
| | (1,6-hexanediol diacrylate) | |
| CN964A85 | Aliphatic urethane acrylate | Difunctional |
| | diluted with 15% TPGDA | |
| CN965 | Aliphatic urethane acrylate | Difunctional |
| CN966H90 | Aliphatic urethane acrylate | Difunctional |
| | diluted with 10% EOEOEA | |
| | (2-(2-ethoxyethoxy) | |
| | ethyl acrylate) | |
| CN970A60 | Aromatic urethane acrylate | Trifunctional |
| | diluted with 40% TPGDA | |
| CN9761 | Aromatic urethane acrylate | Difunctional |
| CN9761A75 | Aromatic urethane acrylate | Difunctional |
| | EOEOEA 25% TPGDA | |
| CN981 | Aliphatic urethane acrylate | Difunctional |
| CN9900 | Aliphatic urethane acrylate | — |
| CN991 | Aliphatic urethane acrylate | Difunctional |
| CN996 | Aliphatic urethane acrylate | Difunctional |
| CN998B80 | Aliphatic urethane acrylate | Trifunctional |
| | EOEOEA 20% HDDA | |
| EBECRYL1290 | Aliphatic urethane acrylate | Hexafunctional |

For example, they may be the multifunctional oligomers CN9165A®, CN9167®, CN9210®, CN9215®, CN9276®, CN991®, EBECRYL1290®.

Aliphatic urethane acrylate oligomers are particularly preferred.

Advantageously, the multifunctional oligomer may be an aliphatic urethane diacrylate (such as CN981®, CN9001® or CN991®), tetracrylate (such as CN9276®), or hexacrylate (such as CN9210® or EB1290). Advantageously, the multifunctional oligomer may be an aliphatic urethane diacrylate such as CN981®, CN9001® or CN991®.

Advantageously, the multifunctional oligomer may be a multifunctional aliphatic urethane acrylate oligomer comprising 6 to 9 acrylate functions, preferably an aliphatic urethane hexacrylate (such as CN9210®, CN9215® or EBECRYL1290®), octacrylate or nonacrylate oligomer.

Advantageously, the weight ratio of reactive diluent(s)/multifunctional oligomer(s) may be between 1.3 and 3.5, preferably between 1.3 and 3.0, the ratio being calculated taking into consideration the sum by weight of the acrylate monomers.

Advantageously, the weight ratio of diacrylate monomer/multifunctional oligomer is between 1.3 and 1.7, in particular when the reactive diluent is an aliphatic diacrylate monomer such as SR238®. When a mixture of at least two diacrylate monomers is used, the weight ratio of multifunctional oligomer/diacrylate monomers may be higher and may be between 1.5 and 3.5, in particular between 1.5 and 3.0 for a mixture of two diacrylate monomers such as SR238® and TCDDA (the sum by weight of the acrylate monomers is then taken into consideration for calculating the ratio). The abovementioned weight ratios are most particularly advantageous when the multifunctional oligomer is an aliphatic urethane diacrylate oligomer (such as CN981®, CN9001® or CN991®).

Advantageously, the multifunctional oligomer, preferably an aliphatic urethane diacrylate oligomer, may be present at an amount of 20 to 70% by weight relative to the total weight of the crosslinkable varnish composition. For example, when the reactive diluent is composed of a single diacrylate monomer (such as SR238®), the multifunctional oligomer, preferably an aliphatic urethane diacrylate oligomer, may be present at an amount of 30 to 50%, preferably 35 to 45% by weight relative to the total weight of the crosslinkable varnish composition.

Advantageously, the multifunctional oligomer, preferably an aliphatic urethane oligomer having at least 6 acrylate functions, for example, may be an aliphatic urethane hexacrylate, octacrylate or nonacrylate oligomer, and may be present at an amount of 50 to 65% by weight relative to the total weight of the crosslinkable varnish composition.

### Constituent B—Acrylate Monomer Reactive Diluent

Advantageously, said at least one reactive diluent may be selected from aliphatic acrylate monomers, preferably aliphatic mono-, di-, tetra- or hexacrylate monomers. Preferably, the aliphatic radicals of the reactive diluent are saturated.

Generally speaking, the crosslinkable varnish compositions according to the invention may contain from 20% by weight to 75% by weight of reactive diluent relative to the total weight of the crosslinkable varnish composition according to the invention, which reactive diluent may be used in the form of a mixture of at least two reactive diluents. The reactive diluents, aside from their function of reagent in the polymerization reaction of the composition, also make it possible to define a viscosity of the varnish composition in a range from approximately 10 to approximately 250 mPa·s. For varnish compositions which are intended for flow-coating varnish operations or dip coating operations, it is more common to use low viscosities of the order of 1 to 20 mPa·s. For purposes of blade coating or roll coating, the suitable viscosities are in the range from 20 to 250 mPa·s, Preferably, the methods of application of the varnishes according to the invention comprise spraying sprinkling or roll coating. The values indicated must be considered as indicative values and refer to the measurement of the viscosity at 20° C. with a rotational viscometer according to standard DIN 53 019.

The acrylate reactive diluents may be chosen from commercially available acrylate monomers, for example from Sartomer.

They comprise monofunctional acrylate monomers, such as:
acrylates derived from saturated alcohols, such as ethyl methacrylate, propyl acrylate, n-butyl acrylate, tert-butyl acrylate, pentyl acrylate, acrylate and 2-ethylhexyl acrylate, for example;
alkyl acrylates, such as 3-hydroxypropyl acrylate, 3,4-dihydroxybutyl acrylate, 2-hydroxyethyl acrylate, 2-hydroxypropyl acrylate;
diacrylates, such as 1,4-butanediol, alkyl diacrylates.

In particular, the acrylate reactive diluents may be chosen from commercially available acrylate monomers, for example from Sartomer. For example, the reactive diluents of use in the context of the present invention may be chosen from:

| Product | | |
|---|---|---|
| reference | Chemical name | Functionality |
| CD406 | Cyclohexane Dimethanol Diacrylate | Difunctional |
| CD553 | Methoxy Polyethylene Glycol (550) | Monofunctional |
| | Monoacrylate | |
| CD595 | Acrylate Ester | Difunctional |
| CD9075 | Alkoxylated Lauryl Acrylate | Monofunctional |
| DPHA | Dipentaerythritol Hexaacrylate | Hexafunctional |
| SR217 NS | Cycloaliphatic Acrylate Monomer | Monofunctional |
| SR238 TFN | 1,6-Hexanediol Diacrylate | Difunctional |
| SR256 | 2(2-Ethoxyethoxy) Ethyl Acrylate | Monofunctional |
| SR259 | Polyethylene Glycol (200) Diacrylate | Difunctional |
| SR268 | Tetraethylene Glycol Diacrylate | Difunctional |
| SR285 | Tetrahydrofurfuryl Acrylate | Monofunctional |
| SR295 NS | Pentaerythritol Tetraacrylate | Tetrafunctional and |
| | | pentafunctional |
| SR306 NS | Tripropylene Glycol Diacrylate | Difunctional |
| SR306 TFN | Tripropylene Glycol Diacrylate | Difunctional |
| SR335 | Lauryl Acrylate | Monofunctional |
| SR339 NS | 2-Phenoxyethyl Acrylate | Monofunctional |
| SR344D NS | Polyethylene Glycol (400) Diacrylate | Difunctional |
| SR349 NS | (3) Ethoxylated Bisphenol A Diacrylate | Difunctional |
| SR351 NS | Trimethylolpropane Triacrylate | Trifunctional |
| SR351 TFN | Trimethylolpropane Triacrylate | Trifunctional |
| SR355 HV | Di-Trimethylolpropane Tetraacrylate | Tetrafunctional and |
| NS | | pentafunctional |
| SR355 NS | Di-Trimethylolpropane Tetraacrylate | Tetrafunctional and |
| | | pentafunctional |
| SR355 TFN | Di-Trimethylolpropane Tetraacrylate | Tetrafunctional and |
| | | pentafunctional |
| SR368D NS | Tris (2-Hydroxy Ethyl) Isocyanurate | Trifunctional |
| | Triacrylate | |
| SR368 NS | Tris (2-Hydroxy Ethyl) Isocyanurate | Trifunctional |
| | Triacrylate | |
| SR395 NS | Isodecyl Acrylate | Monofunctional |
| SR399 LV | Low-Density Dipentaerythritol | Tetrafunctional and |
| NS | Pentaacrylate | pentafunctional |
| SR399 NS | Dipentaerythritol Pentaacrylate | Tetrafunctional and |
| | | pentafunctional |
| SR415 | (20) Ethoxylated Trimethylolpropane | Trifunctional |
| | Triacrylate | |
| SR420 NS | Acrylic Monomer | Monofunctional |
| SR444D NS | Pentaerythritol Triacrylate | Trifunctional |
| SR444 NS | Pentaerythritol Triacrylate | Trifunctional |
| SR454 NS | (3) Ethoxylated Trimethylolpropane | Trifunctional |
| | Triacrylate | |
| SR454 TFN | (3) Ethoxylated Trimethylolpropane | Trifunctional |
| | Triacrylate | |
| SR484 | Octyldecyl Acrylate | Monofunctional |
| SR489D | Tridecyl Acrylate | Monofunctional |
| SR492 TFN | (3) Propoxylated Trimethylolpropane | Trifunctional |
| | Triacrylate | |
| SR494 NS | (4) Ethoxylated Pentaerythritol | Tetrafunctional and |
| | Tetraacrylate | pentafunctional |
| SR495B NS | Caprolactone Acrylate | Monofunctional |
| SR499 NS | (6) Ethoxylated Trimethylolpropane | Trifunctional |
| | Triacrylate | |
| SR502 NS | (9) Ethoxylated Trimethylolpropane | Trifunctional |
| | Triacrylate | |
| SR504 NS | (4) Ethoxylated Nonyl Phenol Acrylate | Monofunctional |
| SR506 NS | Isobornyl Acrylate | Monofunctional |
| SR508 NS | Dipropylene Glycol Diacrylate | Difunctional |
| SR508 TFN | Dipropylene Glycol Diacrylate | Difunctional |
| SR531 | Cyclic Trimethylolpropane Formal | Monofunctional |
| | Acrylate | |
| SR551 | Methoxy Polyethylene Glycol (350) | Monofunctional |
| | Monoacrylate | |
| SR601 NS | (4) Ethoxylated Bisphenol A Diacrylate | Difunctional |
| SR602 NS | Ethoxylated Bisphenol A diacrylate | Difunctional |
| SR610 NS | Polyethylene Glycol (600) Diacrylate | Difunctional |
| SR614 NS | Alkoxylated Nonylphenol Acrylate | Monofunctional |
| SR833 NS | Tricyclodecane Dimethanol Diacrylate | Difunctional |
| SR9003 NS | (2) Propoxylated Neopentyl Glycol | Difunctional |
| | Diacrylate | |
| SR9003 | (2) Propoxylated Neopentyl Glycol | Difunctional |
| TFN | Diacrylate | |
| SR9020 NS | (3) Propoxylated Glyceryl Triacrylate | Trifunctional |
| SR9020 | (3) Propoxylated Glyceryl Triacrylate | Trifunctional |
| TFN | | |
| SR9035 | (15) Ethoxylated Trimethylolpropane | Trifunctional |
| | Triacrylate | |
| SR9050 | Monofunctional Acid Ester | Monofunctional |
| SR9051 NS | Trifunctional Acid Ester | Trifunctional |
| SR9053 | Trifunctional Acid Ester | Trifunctional |

Advantageously, said at least one reactive diluent may be a mixture of two acrylate monomers selected from mono-, di-, tetra- or hexacrylate monomers, preferably aliphatic mono-, di-, tetra or hexacrylate monomers. For example, these may be mono-, di- or tetracrylate monomers such as isobornyl acrylate (SR506®), tetrahydrofurfuryl acrylate (SR285®), 1,6-hexanediol diacrylate (SR238®), tricyclodecane dimethanol diacrylate (SR833S®) and SR355®, more advantageously a mixture of two aliphatic diacrylate monomers, such as SR238® or SR833S®.

| Acrylate monomer reactive dilent | Structure |
|---|---|
| SR506 ® | [chemical structure] |
| SR285 ® | [chemical structure] |
| SR238 ® | [chemical structure] |
| SR833S ® | [chemical structure] |
| SR355 ® | [chemical structure] |

Advantageously, the reactive diluent contains at least one diacrylate monomer, preferably an aliphatic diacrylate monomer. Advantageously, said at least one reactive diluent may be selected from diacrylate monomers, preferably aliphatic diacrylate monomers. For example, this may be SR238® or SR833S®. Advantageously, said at least one reactive diluent may be a mixture of at least two diacrylate monomers, preferably exactly two diacrylate monomers, preferably aliphatic. For example, this may be a mixture of SR238® and SR833S®.

Advantageously, the compositions according to the invention may comprise at least one acrylate monomer reactive diluent, in which the reactive diluent(s)/multifunctional oligomer(s) weight ratio is between 1.3 and 3.5, preferably between 1.5 and 3.0, the ratio being calculated taking into consideration the sum by weight of the acrylate monomers.

Advantageously, the compositions according to the invention may comprise at least two acrylate monomer reactive diluents, in which the reactive diluents/multifunctional oligomers weight ratio is between 1.5 and 3.5, in particular between 1.5 and 3.0 (the sum by weight of the acrylate monomers is taken into consideration for calculating the ratio). Preferably, the two reactive diluents may be aliphatic or alicyclic diacrylate monomers. Most preferentially, this may be a mixture of an aliphatic diacrylate monomer reactive diluent and an alicyclic diacrylate monomer reactive diluent; for example, a mixture of SR238® and SR833S®.

Advantageously, the compositions according to the invention may comprise a diacrylate monomer as reactive diluent (such as SR238®), in which the diacrylate monomer/multifunctional oligomer weight ratio is between 1.3 and 1.7. When the multifunctional oligomer/diacrylate monomer weight ratio is within this range, the adhesion of the crosslinkable varnish composition according to the invention to the substrate onto which it is coated/deposited is improved. This diacrylate monomer/multifunctional oligomer weight ratio is also important for the scratch resistance of the finished varnish (after crosslinking). When the diacrylate monomer/multifunctional oligomer weight ratio is between 1.3 and 1.7, the scratch resistance of the varnish is improved.

Advantageously, the reactive diluent or mixture of reactive diluents may be present at an amount of 20 to 70% by weight, preferably 30 to 70% by weight, preferably 40 to 70% by weight, relative to the total weight of the composition. The abovementioned percentages are most particularly advantageous when the multifunctional oligomer is an aliphatic urethane diacrylate oligomer (such as CN981®, CN9001® or CN991®). Advantageously, the reactive diluent or mixture of reactive diluents may be present at an amount of 30 to 40% by weight relative to the total weight of the composition. The abovementioned percentages are most particularly advantageous when the multifunctional oligomer is an aliphatic urethane oligomer with an acrylate functionality of greater than or equal to 6; for example, the multifunctional oligomer may be an aliphatic urethane hexacrylate, octacrylate or nonacrylate oligomer.

Advantageously, said at least one reactive diluent enables modulation of the viscosity of the composition and improvement in adhesion to a plastic substrate. This is the case for example of unsaturated aliphatic diacrylate reactive diluents such as SR238®. Advantageously, said at least one reactive diluent may make it possible to increase the crosslinking density and the glass transition temperature (Tg) of the crosslinked varnish. This is the case for example of unsaturated alicyclic diacrylate reactive diluents such as SR833® (also referred to as “TCDDA” in the present document).

### Constituent C—Photoinitiator

The varnish composition according to the invention may be polymerized or crosslinked using known radical photoinitiators which are added to the varnish composition at an amount of 0.01% by weight to 10% by weight, preferably 1% by weight to 6% by weight, preferably 1% by weight to 3% by weight, relative to the total weight of the crosslinkable varnish composition.

Under the action of UV-visible radiation, the photoinitiator generates radicals which will be responsible for the initiation of the photopolymerization reaction, and therefore makes it possible to increase the efficiency of the photopolymerization reaction. It is of course chosen as a function of the light source used, according to its ability to effectively absorb the selected radiation. It will for example be possible to choose the suitable photoinitiator using its UV-visible absorption spectrum. Advantageously, the photoinitiator is suitable for working with irradiation sources that emit in the near-visible range.

Advantageously, the source of UV or visible radiation may be an LED or a discharge lamp. For example, it may be an Hg/Xe lamp. Natural light may also be used. Of course, a suitable photoinitiator will have to be used.

Advantageously, said at least one photoinitiator may be chosen from:
type I radical photoinitiators
   of the family of the acetophenones, alkoxyacetophenones and derivatives such as 2,2-dimethoxy-2-phenylacetophenone and 2,2-diethyl-2-phenylacetophenone;
   of the family of the hydroxyacetophenones and derivatives such as 2,2-dimethyl-2-hydroxyacetophenone, 1-hydroxycyclohexylphenyl ketone, 2-hydroxy-4′-(2-hydroxyethoxy)-2-methylpropiophenone and 2-hydroxy-4′-(2-hydroxypropoxy)-2-methylpropiophenone;
   of the family of alkylaminoacetophenones and derivatives such as 2-methyl-4′-(methylthio)-2-morpholinopropiophenone, 2-benzyl-2-(dimethylamino)-4-morpholinobutyrophenone and 2-(4-(methylbenzyl)-2-(dimethylamino)-4-morpholinobutyrophenone;
   of the family of benzoin ethers and derivatives such as benzyl, benzoin methyl ether and benzoin isopropyl ether;
   of the family of phosphine oxides and derivatives such as diphenyl(2,4,6-tri methyl benzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
type II radical photoinitiators
   of the family of benzophenones and derivatives such as 4-phenylbenzophenone, 4-(4′-methylphenylthio)benzophenone, 1-[4-[(4-benzoylphenyl)thio]phenyl]-2-methyl-2-[(4-methylphenyl)sulfonyl]-1-propanone;
   the family of thioxanthones and derivatives such as isopropylthioxanthone (ITX), 2,4-diethylthioxanthone, 2,4-dimethylthioxanthone, 2-chlorothioxanthone and 1-chloro-4-isopropylthioxanthone;
   the family of quinones and derivatives such as anthraquinones including 2-ethylanthraquinone and camphorquinones;
   the family of esters of benzoyl formate and derivatives such as methyl benzoylformate; the family of metallocenes and derivatives such as ferrocene, titanium bis(eta 5-2,4-cyclopentadien-1-yl)bis(2,6-difluoro)-3-(1H-pyrrol-1-yl)phenyl) and (cumene)cyclopentadienyl iron hexafluorophosphate;
   the family of dibenzylidene ketones and derivatives such as p-dimethylaminoketone;
   the family of coumarins and derivatives such as 5-methoxy and 7-methoxy coumarin, 7-diethylamino coumarin and N-phenylglycine coumarin;
photoinitiators of the family of dyes such as triazines and derivatives, fluorones and derivatives, cyanins and derivatives, safranins and derivatives, 4,5,6,7-tetrachloro-3′,6′-dihydroxy-2′,4′,5′,7-tetraiodo-3H-spiro[isobenzofuran-1,9′-xanthen]-3-one, pyrylium and thiopyrylium and derivatives, thiazines and derivatives, flavins and derivatives, pyronines and derivatives, oxazines and derivatives, rhodamines and derivatives;
a mixture of at least two of the abovementioned photoinitiators.

The photoinitiator will be chosen as a function of the light source used for the polymerization/crosslinking. Advantageously, preference is given to type I radical photoinitiators. By way of example, when the source of UV or visible radiation is an LED, the photoinitiator may be chosen from: TPO, TPO-L, BAPO, Irgacure 369®, Irgacure 907®, Irgacure 184®, or a mixture of at least two thereof.

### Constituent D—Surface Agent

Here, mention may for example be made of surfactants that make it possible to regulate the surface tension of the crosslinkable varnish composition and to obtain good application properties. To this end, it is possible for example to use silicones, such as various types of polymethylsiloxanes, in concentrations of between 0.1% by weight and 10% by weight, preferably between 1% and 10% by weight, preferably between 1% and 5% by weight of the total weight of the composition. The reader may for example refer to document EP 0 035 272. [1]

Advantageously, the surface agent may be an agent based on silicone or based on acrylic copolymer. It may preferably be a surface agent based on silicone such as a polyether-modified polydimethylsiloxane (BYK-302®) or multi-acrylate modified polydimethylsiloxane (BYK-UV 35050).

Advantageously, the surface agent makes it possible to increase the wettability of the composition and to copolymerize with the formulation.

### Constituent E—UV Stabilizer

Advantageously, the compositions according to the invention may also comprise at least one UV stabilizer chosen from UV absorbers (such as benzotriazole (BTZ) and derivatives, hydroxybenzophenone (HBP) and derivatives, or hydroxyphenyl triazine (HPT) and derivatives) and free radical scavengers from the family of sterically hindered amines (such as the following compounds:

[chemical structure]

The main function of a UV absorber is to protect the layer of varnish from the deleterious effects of solar irradiation, in order to prevent the degradation and discoloration of the varnish. In contrast, the function of free-radical scavengers, mainly those from the family of sterically hindered amines, is to prevent oxidative degradation of the upper layer of the varnish.

Advantageously, said at least one stabilizer is present in concentrations of between 0.1% by weight and 10% by weight, preferably between 1% and 10% by weight of the total weight of the composition.

### Constituent F—Hybrid Variant

Advantageously, the composition may also comprise a hybrid organic-inorganic reactive diluent that may react by photopolymerization and photosol-gel reaction, of formula (II)
in which
m represents an integer between 1 and 3;
each instance of R⁴ independently represents a non-hydrolyzable group covalently bonded to Si via a carbon atom, it being understood that at least one instance of R⁴ comprises an unsaturated photopolymerizable group; and
each instance of R⁵ independently represents a hydrolyzable group selected from C1-C6 alkoxy, C1-C6 acyloxy, a halogen atom or an amino group; preferably C1-C6 alkoxy such as methoxy or ethoxy, preferably methoxy.

Advantageously, the unsaturated photopolymerizable group may be an acrylate or methacrylate group.

Advantageously, at least one instance of R⁴ comprises an unsaturated photopolymerizable group capable of polymerizing with one of the polymerizable groups of the urethane acrylate oligomer and/or of said at least one acrylate monomer, or of the polymerization product itself.

The combined use of the photosol-gel process for reinforcing photocrosslinkable coatings is known and has been reported especially in Belon et al., Macromol. Mater. Eng., 2011, 296(6), 506-516 [2], and Belon et al., J. polym. Sci.: Part A: Polymer Chemistry, 2010, 48(19), 4150-4158 [3].

A particular use of polymerization by photosol-gel is also described in application WO 2013/171582 [4] for producing stronger protective coatings, especially for metal substrates.

Advantageously, the hybrid reactive diluent of formula (II) is in liquid form at the temperature at which the polymerization is carried out. Preferably, the implementation process is carried out at room temperature (25° C.±3° C.). The hybrid reactive diluent of formula (II) is therefore preferably in liquid form at 25° C.±3° C.

In formula (II), each of the R⁴ groups may independently of one another be any type of hydrocarbyl group comprising C and H atoms optionally interrupted by at least one heteroatom chosen from oxygen, sulfur and nitrogen atoms; and may for example comprise alkyl groups, cycloalkyl groups, alkenyl groups, cycloalkenyl groups, aromatic groups, which are optionally interrupted by at least one heteroatom chosen from oxygen, sulfur and nitrogen atoms, and may be linear or branched.

Preferably, in the hybrid reactive diluent of formula (II), m represents 3.

Preferably, the hybrid reactive diluent of formula (II) is an organo mono(trialkoxysilane) in which:
each instance of R⁵ independently represents a linear or branched alkoxyl group having 1 to 6 carbon atoms, preferably each instance of R⁵ independently represents methoxy or ethoxy, preferably methoxy, and
each instance of R⁴ independently represents a linear or branched alkyl group having 1 to 20 carbon atoms, preferably 4 to 16 carbon atoms, more preferentially 8 to 12 carbon atoms, optionally interrupted by at least one heteroatom chosen from oxygen, sulfur and nitrogen atoms; a cycloalkyl group having 3 to 20 carbon atoms, for example 6 carbon atoms (cyclohexyl); a linear or branched alkenyl group having 1 to 20 carbon atoms such as a vinyl group; an aryl group having 3 to 20 carbon atoms such as a phenyl group, a C1-C20 alkyl-C3-C20 aryl group; or a C3-C20 aryl-C1-C20 alkyl group; and R⁴ being optionally substituted by one or more substituents selected from the group consisting of halogen atoms, amino groups (NH₂) and SH groups, it being understood that at least one instance of R⁴ comprises an unsaturated photopolymerizable group.

It will be appreciated that all the alkyl groups may be linear or branched.

The R⁴ alkyl or cycloalkyl groups may be perfluorinated.

Advantageously, in the silane compound of formula (II), each instance of R⁴ independently represents a non-hydrolyzable group as defined above, covalently bonded to Si via a carbon atom, and it being understood that at least one instance of R⁴ comprises an unsaturated photopolymerizable hydrocarbyl group comprising at least one heteroatom chosen from oxygen and nitrogen atoms, such as an acrylate or methacrylate group; and each instance of R⁵ independently represents a hydrolyzable group selected from C1-C6 alkoxy, such as methoxy or ethoxy, preferably methoxy.

Advantageously, the silane compound of formula (II) may be:

[chemical structure]

Preferably, the silane compound of formula (II) may be:

[chemical structure]

The incorporation of a hybrid reactive diluent of formula (II) into the compositions according to the invention makes it possible to increase the crosslinking density of the varnish via a second inorganic network created in situ.

Advantageously, the hybrid reactive diluent of formula (II) is added at an amount of 1 to 50% by weight, for example, 25 to 35% by weight, or approximately 30% by weight of the total weight of the crosslinkable varnish composition.

According to one variant, when the crosslinkable varnish composition also contains a hybrid organic-inorganic reactive diluent as described above, said at least one photoinitiator may likewise also contain at least one cationic photoinitiator selected from onium salts, organometallic complexes and non-ionic photoacids.

For example, the onium salts may be chosen from onium hexafluoroantimonate, hexafluorophosphate or tetrafluoroborate salts; such as (4-methylphenyl)[4-(2-methylpropyl)phenyl]iodonium hexafluorophosphate salt, bis(4-methylphenyl)iodonium hexafluorophosphate salt, bis(dodecylphenyl)iodonium hexafluorophosphate salt, 9-(4-hydroxyethoxyphenyl)thianthrenium hexafluorophosphate salt, diphenyliodonium triflate, or a mixture of at least two thereof.

The organometallic complexes may be chosen from metallocenium salts, preferably from ferrocenium salts such as cumene cyclopentadienyl iron hexafluorophosphate.

The non-ionic photoacids may be chosen from alkyl/aryl sulfonic acids, fluorinated sulfonic acids, sulfonimides, tetraaryl boronic acids, or a mixture of at least two thereof.

Advantageously, the cationic photoinitiator may be Irgacure250 of formula:

[chemical structure]

Generally speaking, all the iodonium salts known in the art may be used as cationic photoinitiator in the context of the invention. For example, this may be cationic photoinitiators such as (4-methylphenyl)[4-(2-methylpropyl)phenyl]iodonium hexafluorophosphate salt, bis(4-methylphenyl)iodonium hexafluorophosphate salt, bis(dodecylphenyl)iodonium hexafluorophosphate salt, 9-(4-hydroxyethoxyphenyl)thianthrenium hexafluorophosphate salt, diphenyliodonium triflate, or a mixture of at least two thereof.

Advantageously, the cationic photoinitiator is added at an amount of 1 to 10% by weight of the total weight of the crosslinkable varnish composition.

### Customary Additives

The composition may also comprise any other additive customarily used in the field of varnishes and applications for materials coated with varnish. Examples of suitable additives comprise:
pigments, such as colored pigments, fluorescent pigments, electrically conductive pigments, magnetic shielding pigments, metal powders, scratch-proofing pigments, organic dyes, or mixtures thereof;
light stabilizers such as benzotriazoles or oxalanilides;
slip additives;
defoamers;
adhesion promoters such as tricyclodecanedimethanol;
leveling agents;
film-forming adjuvants such as cellulose derivatives;
flame retardants;
sag control agents such as ureas or modified silicas and/or ureas;
rheology control additives such as those described in patent documents WO 94/22968 [5], EP0276501A1 [6], EP0249201A1 [7], and WO 97/12945 [8];
crosslinked polymer microparticles, as described for example in EP0008127A1 [9];
inorganic phyllosilicates such as magnesium aluminum silicates, sodium magnesium phyllosilicates or magnesium sodium lithium fluoride phyllosilicates of montmorillonite type;
silicas such as Aerosil® silicas;
flatting agents such as magnesium stearate; and/or
tackifiers.

Mixtures of at least two of these additives are also suitable in the context of the invention;
functionalized nanoparticles, such as R7200®. The latter may be used in the crosslinkable varnish compositions according to the invention at an amount of 0.1 to 10% by weight relative to the total weight of the composition. Use may also be made of the products from the Nanocryl® range from Evonik, in particular the Nanocryl® in the range 200, 210, 215, 220, 223, 225, 235 and 370 which are designed for structural adhesive applications and which are colloidal dispersions of silica in mono-, di- or trifunctional acrylate monomers, tri- or tetrafunctional acrylate polyethers, or methacrylate monomers. The nanocomposite acrylate coatings sold by Cetelon Nanotechnik GmbH under the trade name CETOSIL® which contain up to 30% of nanometric silica may also be used in this context. The products of the CETOSIL® range contain surface-functionalized silica nanoparticles which provide the transparency and low viscosity of these coatings.

In the present document, the term “tackifiers” relates to polymer adhesives which increase the tack, that is to say the intrinsic self-adhesion or viscosity, of the compositions such that, after light pressure for a short period, they solidly adhere to surfaces.

### Absence of Solvent

One of the advantages of the varnish compositions according to the invention is that they are crosslinkable in the absence of solvent. The reactive diluents B) and F) contribute to dissolving the whole of the reaction mixture, and serve as organic solvent.

Nonetheless, it is possible to carry out the invention in the presence of an organic solvent. In this case, any organic solvent conventionally used in UV-crosslinkable resins may be used. Document EP 0 035 272 [1], for example, describes customary organic solvents for coating compositions for scratch-resistant coating materials, which may be used as diluents. These may be, for example:
alcohols such as ethanol, isopropanol, n-propanol, isobutyl alcohol and n-butyl alcohol, methoxypropanol, methoxyethanol;
aromatic solvents such as benzene, toluene or xylene, for example;
ketones such as acetone or methylethyl ketone.

It is also possible to use ethereal solvents, such as diethyl ether compounds or an ester such as ethyl acetate, n-butyl acetate or ethyl propionate, for example. The solvents may be used alone or in combination.

However, the main variant of the invention remains the one which does not use any solvent other than the reactive diluents A) to F) described above.

Variant 1: Advantageously, in the crosslinkable varnish composition according to the invention:
the multifunctional oligomer may be an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer (such as CN981®, CN9001® or CN991®);
said at least one reactive diluent may be selected from aliphatic acrylate monomers, preferably aliphatic mono-, di-, tetra- or hexacrylate monomers, most preferentially aliphatic diacrylate monomers, for example SR238®;
the photoinitiator may be selected from radical photoinitiators such as diphenyl-(2,4,6-trimethylbenzoyl)phosphine oxide (TPO), ethyl(2,4,6-trimethylbenzoyl)phenylphosphine oxide (TPO-L), bis(trimethylbenzoyl)phenylphosphine oxide (BAPO), 2-(dimethylamino)-1-(4-(4-morpholinyl)phenyl)-2-(phenylmethyl)-1-butanone (irgacure 3690), irgacure 13000 (2-(dimethylamino)-1-(4-(4-morpholinyl)phenyl)-2-(phenylmethyl)-1-butanone (30% by weight)+alpha,alpha-dimethoxy-alpha-phenylacetophenone (70% by weight)), 2-methyl-1-[4-(methylthio)phenyl]-2-(4-morpholinyl)-1-propanone (irgacure 9070); or a mixture of at least two thereof; preferably 1-hydroxycyclohexylphenyl ketone (Irgacure 1840).
Advantageously, the multifunctional oligomer, preferably an aliphatic urethane diacrylate oligomer, may be present at an amount of 25 to 50%, preferably 40 to 50% by weight relative to the reactive diluent. Conversely, the reactive diluent, preferably chosen from aliphatic diacrylate monomers, may be present at an amount of 50 to 75%, preferably 50 to 60% by weight relative to the urethane acrylate oligomer.
Advantageously, the multifunctional oligomer, preferably an aliphatic urethane diacrylate oligomer, may be present at an amount of 30 to 50% by weight, preferably 35 to 45% by weight; and the reactive diluent, preferably chosen from aliphatic diacrylate monomers, may be present at an amount of 40 to 60%, preferably 45 to 55% by weight relative to the total weight of the crosslinkable varnish composition. The radical photoinitiator may advantageously be present at an amount of 1 to 10% by weight of the total weight of the crosslinkable varnish composition.
Advantageously, the weight ratio of reactive diluent(s)/multifunctional oligomer(s) may be between 1.3 and 3.5, preferably between 1.3 and 3.0, the ratio being calculated taking into consideration the sum by weight of the acrylate monomers.
Advantageously, the weight ratio of diacrylate monomer/multifunctional oligomer may be between 1.3 and 1.7, in particular when the reactive diluent is an aliphatic diacrylate monomer such as SR238®, most particularly when the multifunctional oligomer is an aliphatic urethane diacrylate oligomer (such as CN981®, CN9001® or CN991®).
The composition may also comprise functionalized nanoparticles, such as Aerosil R7200®, at an amount of 0.1 to 10% by weight of the total weight of the composition.

Variant 2: Advantageously, in the crosslinkable varnish composition according to the invention:
the multifunctional oligomer may be an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer (such as CN981®, CN9001® or CN991®);
said at least one reactive diluent may be a mixture of two acrylate monomers selected from mono-, di-, tetra- or hexacrylate monomers, preferably aliphatic mono-, di-, tetra or hexacrylate monomers. For example, these may be mono-, di- or tetracrylate monomers such as isobornyl acrylate (SR506®), tetrahydrofurfuryl acrylate (SR285®), 1,6-hexanediol diacrylate (SR238®), tricyclodecane dimethanol diacrylate (SR833S®) and SR355®, more advantageously a mixture of two aliphatic diacrylate monomers, even more advantageously a mixture of an acyclic aliphatic diacrylate monomer and an alicyclic diacrylate monomer, such as SR238® or SR833S®, respectively. Advantageously, the acyclic aliphatic diacrylate monomer (such as SR238®) and the alicyclic diacrylate monomer (such as SR833S®) are present in a weight ratio of 40/60 to 90/10, preferably 45/55 to 85/15.
the photoinitiator may be selected from diphenyl(2,4,6-trimethylbenzoyl)phosphine oxide (TPO), ethyl(2,4,6-trimethylbenzoyl)phenylphosphine oxide (TPO-L), bis(trimethylbenzoyl)phenylphosphine oxide (BAPO), 2-(dimethylamino)-1-(4-(4-morpholinyl)phenyl)-2-(phenylmethyl)-1-butanone (irgacure 3690), irgacure 1300® (2-(dimethylamino)-1-(4-(4-morpholinyl)phenyl)-2-(phenylmethyl)-1-butanone (30% by weight)+alpha,alpha-dimethoxy-alpha-phenylacetophenone (70% by weight), 2-methyl-1-[4-(methylthio)phenyl]-2-(4-morpholinyl)-1-propanone (irgacure 907®); or a mixture of at least two thereof; preferably TPO, TPO-L, BAPO, Irgacure 369®, Irgacure 907®, 1-hydroxycyclohexylphenyl ketone (Irgacure 184®), or a mixture of at least two thereof.
Advantageously, the multifunctional oligomer, preferably an aliphatic urethane diacrylate oligomer, may be present at an amount of 30 to 70%, preferably 35 to 65% by weight relative to the mixture of the two aliphatic diacrylate monomers. Conversely, the mixture of the two aliphatic diacrylate monomers may be present at an amount of 30 to 70%, preferably 35 to 65% by weight relative to the urethane acrylate oligomer, preferably an aliphatic urethane diacrylate oligomer. (The sum by weight of the diacrylate monomers is taken into consideration for calculating these percentages).
Advantageously, the multifunctional oligomer, preferably an aliphatic urethane diacrylate oligomer, may be present at an amount of 20 to 50% by weight, preferably 20 to 40% by weight; and the mixture of the two acrylate monomers (preferably aliphatic or alicyclic diacrylate monomers) may be present at an amount of 50 to 70%, preferably 55 to 70% by weight relative to the total weight of the crosslinkable varnish composition. The radical photoinitiator is advantageously present at an amount of 1 to 10% by weight of the total weight of the crosslinkable varnish composition.
Advantageously, in any one of the abovementioned variants in which the reactive diluent may comprise a mixture of two aliphatic or alicyclic diacrylate monomers, the reactive diluents/multifunctional oligomers weight ratio is between 1.3 and 3.5.
Advantageously, in any one of the abovementioned variants in which the reactive diluent comprises a mixture of two aliphatic or alicyclic diacrylate monomers, the diacrylate reactive diluents/multifunctional oligomer weight ratio may be between 1.5 and 3.5, preferably between 1.5 and 3.0 (in order to calculate this ratio, the sum by weight of the two reactive diluents is taken into consideration), advantageously when the multifunctional oligomer is an aliphatic urethane diacrylate oligomer (such as CN981®, CN9001® or CN991®).
The composition may also comprise functionalized nanoparticles, such as R7200, at an amount of 0.1 to 10% by weight of the total weight of the composition.

Variant 3: Advantageously, in the crosslinkable varnish composition according to the invention:
the multifunctional oligomer may be an aliphatic urethane diacrylate (such as CN981®, CN9001® or CN991®), tetracrylate (such as CN9276®), hexacrylate (such as CN9210® or EB1290) oligomer, or have an acrylate functionality of greater than or equal to 6; for example, the multifunctional oligomer may advantageously be an aliphatic urethane hexa-, octa- or nonacrylate oligomer; said at least one reactive diluent may be chosen from aliphatic acrylate monomers, preferably aliphatic mono-, di-, tetra- or hexacrylate monomers, most preferentially aliphatic diacrylate monomers, for example SR238®;
the photoinitiator may be selected from radical photoinitiators such as diphenyl-(2,4,6-trimethylbenzoyl)phosphine oxide (TPO), ethyl(2,4,6-trimethylbenzoyl)phenylphosphine oxide (TPO-L), bis(trimethylbenzoyl)phenylphosphine oxide (BAPO), 2-(dimethylamino)-1-(4-(4-morpholinyl)phenyl)-2-(phenylmethyl)-1-butanone (irgacure 369®), irgacure 13000 (2-(dimethylamino)-1-(4-(4-morpholinyl)phenyl)-2-(phenylmethyl)-1-butanone (30% by weight)+alpha,alpha-dimethoxy-alpha-phenylacetophenone (70% by weight)), 2-methyl-1-[4-(methylthio)phenyl]-2-(4-morpholinyl)-1-propanone (irgacure 907®); or a mixture of at least two thereof; preferably 1-hydroxycyclohexylphenyl ketone (Irgacure 184®).
Advantageously, the multifunctional oligomer, preferably an aliphatic urethane hexa-, octa- or nonacrylate oligomer, may be present at an amount of 45 to 65% by weight, preferably 50 to 60% by weight; the reactive diluent may be present at an amount of 25 to 45%, preferably 30 to 40% by weight; the radical photoinitiator may be present at an amount of 5 to 15%, preferably 5 to 7% by weight relative to the total weight of the crosslinkable varnish composition.
Advantageously, the multifunctional oligomer, preferably an aliphatic urethane hexa-, octa- or nonacrylate oligomer, may be present at an amount of 50 to 65% by weight; the reactive diluent may be present at an amount of 30 to 40% by weight; the radical photoinitiator may be present at an amount of 1 to 6% by weight, of the total weight of the crosslinkable varnish composition. The composition may also comprise functionalized nanoparticles such as colloidal dispersions of silica in mono-, di- or trifunctional acrylate monomers, tri- or tetrafunctional acrylate polyethers or methacrylate monomers, such as the products of the Nanocryl® range from Evonik, in particular the Nanocryl® in the 200, 210, 215, 220, 223, 225, 235 and 370 range, at an amount of 0.1 to 10% by weight of the total weight of the composition.
Advantageously, the weight ratio of reactive diluent(s)/multifunctional oligomer(s) may be between 1.5 and 3.5, preferably between 1.3 and 3.0, the ratio being calculated taking into consideration the sum by weight of the acrylate monomers.

Variant 4: Advantageously, in the crosslinkable varnish composition according to the invention:
the multifunctional oligomer may be an aliphatic urethane diacrylate (such as CN981®, CN9001® or CN991®), tetracrylate (such as CN9276®), hexacrylate (such as CN9210® or EB1290) oligomer, or have an acrylate functionality of greater than or equal to 6; for example, the multifunctional oligomer may advantageously be an aliphatic urethane hexa-, octa- or nonacrylate oligomer;
said at least one reactive diluent may be a mixture of two acrylate monomers selected from mono-, di-, tetra- or hexacrylate monomers, preferably aliphatic mono-, di-, tetra or hexacrylate monomers. For example, these may be mono-, di- or tetracrylate monomers such as isobornyl acrylate (SR506®), tetrahydrofurfuryl acrylate (SR285®), 1,6-hexanediol diacrylate (SR238®), tricyclodecane dimethanol diacrylate (SR833S®) and SR355®, more advantageously a mixture of two aliphatic diacrylate monomers, such as SR238® or SR833S®;
the photoinitiator may be selected from diphenyl(2,4,6-trimethylbenzoyl)phosphine oxide (TPO), ethyl(2,4,6-trimethylbenzoyl)phenylphosphine oxide (TPO-L), bis(trimethylbenzoyl)phenylphosphine oxide (BAPO), 2-(dimethylamino)-1-(4-(4-morpholinyl)phenyl)-2-(phenylmethyl)-1-butanone (irgacure 369®), irgacure 1300® (2-(dimethylamino)-1-(4-(4-morpholinyl)phenyl)-2-(phenylmethyl)-1-butanone (30% by weight)+alpha,alpha-dimethoxy-alpha-phenylacetophenone (70% by weight)), 2-methyl-1-[4-(methylthio)phenyl]-2-(4-morpholinyl)-1-propanone (irgacure 907®); or a mixture of at least two thereof; preferably TPO, TPO-L, BAPO, Irgacure 369®, Irgacure 907®, 1-hydroxycyclohexylphenyl ketone (Irgacure 184®), or a mixture of at least two thereof.
Advantageously, the multifunctional oligomer, preferably an aliphatic urethane hexa-, octa- or nonacrylate oligomer, may be present at an amount of 50 to 65% by weight; the reactive diluent may be present at an amount of 30 to 40% by weight; the radical photoinitiator may be present at an amount of 1 to 6% by weight, of the total weight of the crosslinkable varnish composition. The composition may also comprise functionalized nanoparticles such as colloidal dispersions of silica in mono-, di- or trifunctional acrylate monomers, tri- or tetrafunctional acrylate polyethers or methacrylate monomers, such as the products of the Nanocryl® range from Evonik, in particular the Nanocryl® in the 200, 210, 215, 220, 223, 225, 235 and 370 range, at an amount of 0.1 to 10% by weight of the total weight of the composition.
Advantageously, in any one of the abovementioned variants in which the reactive diluent may comprise a mixture of two aliphatic or alicyclic diacrylate monomers, the reactive diluents/multifunctional oligomers weight ratio is between 1.3 and 3.5.

Variant 5: Advantageously, in any one of crosslinkable varnish variants 1 to 4 above, a surface agent is present which may be an agent based on silicone or based on acrylic polymer. It may preferably be a surface agent based on silicone such as a polyether-modified polydimethylsiloxane (BYK-302®) or multiacrylate-modified polydimethylsiloxane (BYK-UV 35050). \Advantageously, the surface agent may be present in concentrations of between 0.1% by weight and 10% by weight, preferably between 1% and 10% by weight, preferably between 1% and 5% by weight of the total weight of the composition.

Variant 6: Advantageously, in any one of crosslinkable varnish variants 1 to 5 above, at least one UV stabilizer is present which may be selected from UV absorbers (such as benzotriazole (BTZ) and derivatives, hydroxybenzophenone (HBP) and derivatives, or hydroxyphenyl triazine (HPT) and derivatives) and free radical scavengers from the family of sterically hindered amines (such as the following compounds:

[chemical structure]

Advantageously, said at least one stabilizer is present in concentrations of between 0.1% by weight and 10% by weight, preferably between 1% and 10% by weight of the total weight of the composition.

Variant 7: Advantageously, in any one of crosslinkable varnish variants 1 to 6 above, the composition also comprises:
hybrid organic-inorganic reactive diluent that may react by photopolymerization and photosol-gel reaction, of formula (II) which may be chosen from

[chemical structure]

Advantageously, the hybrid reactive diluent of formula (II) is added at an amount of 1 to 50% by weight, for example, 25 to 35% by weight, or approximately 30% by weight of the total weight of the crosslinkable varnish composition; and
a cationic photoinitiator selected from onium salts, organometallic complexes and non-ionic photoacids, preferably Irgacure 250®. Advantageously, the cationic photoinitiator, such as Irgacure 250®, is added at an amount of 1 to 10% by weight of the total weight of the crosslinkable varnish composition.

Variant 8: Advantageously, the crosslinkable varnish composition according to the invention may comprise:
A) 30 to 50% by weight, preferably 35 to 45% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN981®;
B) an aliphatic diacrylate monomer such as SR238®, as reactive diluent, at an amount of 40 to 60%, preferably 45 to 55% by weight;
C) 1 to 10%, preferably 3 to 7% by weight of a radical photoinitiator as defined in the section “Constituent C—Photoinitiator” on pages 24-27; preferably a type I radical photoinitiator, most preferentially 1-hydroxycyclohexylphenyl ketone (Irgacure 184®);
D) optionally 1 to 10% by weight of a surface agent; and
E) optionally 1 to 10% by weight of a UV stabilizer;
the sum of the percentages of all the components being equal to 100% of the total weight of the composition subjected to crosslinking; and
   wherein the diacrylate monomer/multifunctional oligomer weight ratio is between 1.3 and 1.7.

Variant 9: Advantageously, the crosslinkable varnish composition according to the invention may comprise:
A) 20 to 50% by weight, preferably 20 to 40% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN981®;
B) a mixture of two aliphatic or alicyclic diacrylate monomers, such as SR238® and SR833S®, as reactive diluents, at an amount of 50 to 70%, preferably 55 to 70% by weight;
C) 1 to 10%, preferably 3 to 7% by weight of a radical photoinitiator as defined in the section “Constituent C—Photoinitiator” on pages 24-27; preferably a type I radical photoinitiator, most preferentially 1-hydroxycyclohexylphenyl ketone (Irgacure 184®);
D) optionally 1 to 10% by weight of a surface agent; and
E) optionally 1 to 10% by weight of a UV stabilizer;
the sum of the percentages of all the components being equal to 100% of the total weight of the composition subjected to crosslinking;
wherein the diacrylate monomers/multifunctional oligomer weight ratio is between 1.5 and 3.5, preferably between 1.5 and 3.0; the sum by weight of the two reactive diluents being taken into consideration for calculating this ratio; and
   the acyclic aliphatic diacrylate monomer (such as SR238®) and the alicyclic diacrylate monomer (such as SR833S®) being present in a weight ratio of 40/60 to 90/10, preferably 45/55 to 85/15.

Variant 10: Advantageously, the crosslinkable varnish composition according to the invention may comprise:
A) 45 to 65%, preferably 50 to 60% by weight of an aliphatic urethane oligomer having a functionality of greater than or equal to 6; preferably an aliphatic urethane hexacrylate, octacrylate or nonacrylate oligomer;
B) 25 to 45%, preferably 30 to 40%, by weight of an aliphatic diacrylate monomer as reactive diluent;
C) 5 to 15%, preferably 5 to 7% by weight of a radical photoinitiator as defined in the section “Constituent C—Photoinitiator” on pages 24-27; preferably a type I radical photoinitiator;
D) optionally 1 to 10% by weight of a surface agent, preferably from the class of silicones; and
E) optionally 1 to 10% by weight of a UV stabilizer;
the sum of the percentages of all the components being equal to 100% of the total weight of the composition subjected to crosslinking.

According to another aspect, the invention relates to a process for preparing a scratch-resistant and abrasion-resistant thermoformable varnish, comprising the formation of said varnish by crosslinking a composition according to any one of the variants described above, under the action of UV-visible radiation.

All the embodiments and variants described above in relation to the crosslinkable varnish composition according to the invention may be used for carrying out the abovementioned process.

Advantageously, for carrying out this process, the crosslinkable varnish composition may comprise:
A) at least one multifunctional urethane acrylate oligomer comprising 2 to 9 acrylate functions, which is the product of the reaction of a diisocyanate or triisocyanate with a hydroxylated acrylate monomer, preferably with a stoichiometric excess of a hydroxylated acrylate monomer, said hydroxylated acrylate monomer being a random mixture resulting from the reaction of a polyol with a stoichiometric deficiency of acrylic acid, with the proviso that the chain of the diisocyanate or triisocyanate has not be extended beforehand by a polyol (for example 1,6-hexanediol), polyester, polyether or polycarbonate comprising residual hydroxyl functions;
B) at least one reactive diluent selected from acrylate monomers; and
C) at least one photoinitiator suitable for the light source used for the crosslinking;
D) optionally at least one surface agent; and
E) optionally at least one stabilizing anti-UV agent.

Advantageously, said at least one multifunctional urethane acrylate oligomer comprising 2 to 9 acrylate functions may correspond to one of the formulae I, IA or IB as defined above. In particular, said at least one multifunctional urethane acrylate oligomer comprising 2 to 9 acrylate functions may correspond to the following formula I^{A} or I^{B}:

[chemical structure]

in which:
R₁ represents a C1 to C10 aliphatic, mono- or bicyclic C5 to C8 alicyclic or C6 to C13 aromatic radical, preferably C1 to C10 aliphatic or C5 to C8 alicyclic, optionally substituted with one or more C1-C6 alkyl radicals;
R₂ independently represents a linear, branched or cyclic C1-C10 alkyl group, the C1-C10 alkyl chain being able to be optionally interrupted by an ester (—C(═O)O—) or ether (—O—)-function; and
each instance of n independently represents a mean number of acrylate functions of between 1 and 4, preferably between 1 and 3, preferably between 1 and 2, preferably 1 for the formula I^{A}, and between 1 and 3; preferably between 1 and 2, preferably 1 for the formula I^{B}.

Advantageously, the process may implement any one of crosslinkable varnish variants 1 to 10 described above, preferably with UV-visible radiation, for example with an Hg/Xe lamp.

Advantageously, the crosslinkable varnish composition may correspond to any one of the variants 1 to 10 described above. For example, it may be one of the following compositions 8) to 10):

Composition 8)
30 to 50% by weight, preferably 35 to 45% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN9810;
an aliphatic diacrylate monomer such as SR238®, as reactive diluent, at an amount of 40 to 60%, preferably 45 to 55% by weight;
1 to 10%, preferably 3 to 7% by weight of a radical photoinitiator as defined in the section “Constituent C—Photoinitiator” on pages 24-27; preferably a type I radical photoinitiator, most preferentially 1-hydroxycyclohexylphenyl ketone (Irgacure 184®);
optionally 1 to 10% by weight of a surface agent; and
optionally 1 to 10% by weight of a UV stabilizer;
the sum of the percentages of all the components being equal to 100% of the total weight of the composition subjected to crosslinking; and
wherein the diacrylate monomer/multifunctional oligomer weight ratio is between 1.3 and 1.7;

Composition 9)
20 to 50% by weight, preferably 20 to 40% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN981®;
a mixture of two aliphatic or alicyclic diacrylate monomers, such as SR238® and SR833S®, as reactive diluents, at an amount of 50 to 70%, preferably 55 to 70% by weight;
1 to 10%, preferably 3 to 7% by weight of a radical photoinitiator as defined in the section “Constituent C—Photoinitiator” on pages 24-27; preferably a type I radical photoinitiator, most preferentially 1-hydroxycyclohexylphenyl ketone (Irgacure 184®);
optionally 1 to 10% by weight of a surface agent; and
optionally 1 to 10% by weight of a UV stabilizer;
the sum of the percentages of all the components being equal to 100% of the total weight of the composition subjected to crosslinking;
wherein the diacrylate monomers/multifunctional oligomer weight ratio is between 1.3 and 3.5, preferably between 1.5 and 3.5, even more preferably between 1.5 and 3.0; the sum by weight of the two reactive diluents being taken into consideration for calculating this ratio; and
the acyclic aliphatic diacrylate monomer (such as SR238®) and the alicyclic diacrylate monomer (such as SR833S®) are present in a weight ratio of 40/60 to 90/10, preferably 45/55 to 85/15;

or Composition 10)
45 to 65%, preferably 50 to 60% by weight of an aliphatic urethane oligomer having a functionality of greater than or equal to 6; preferably an aliphatic urethane hexacrylate, octacrylate or nonacrylate oligomer;
25 to 45%, preferably 30 to 40%, by weight of an aliphatic diacrylate monomer as reactive diluent;
5 to 15%, preferably 5 to 7% by weight of a radical photoinitiator as defined in the section “Constituent C—Photoinitiator” on pages 24-27; preferably a type I radical photoinitiator;
optionally 1 to 10% by weight of a surface agent, preferably from the class of silicones; and
optionally 1 to 10% by weight of a UV stabilizer;
the sum of the percentages of all the components being equal to 100% of the total weight of the composition subjected to crosslinking.

Advantageously, the process according to the invention may generally be carried out using conventional processes for mixing the components described above in a suitable mixing device, such as, but without being limited thereto, stirred tanks, dissolvers, homogenizers, microfluidizers, extruders, or other equipment conventionally used in the field.

Advantageously, the process may be carried out in the absence or presence of solvent. Preferably, the process may be carried out in the absence of solvent, which constitutes one of the major advantages of the present invention.

According to another aspect, the present invention relates to a process for protecting a support from scratches and abrasion, said support preferably being thermoformable or thermally drape-formable, said process comprising:

a) coating the surface of an optionally thermoformable or thermally drape-formable support with a varnish composition according to any one of the variants described in the present document;

b) curing the varnish composition covering the coated surface of the support by crosslinking said composition under the action of UV-visible radiation; and

c) in the case in which said support is thermoformable or thermally drape-formable, optionally shaping the varnished support by thermoforming or thermal drape forming.

Advantageously, said process for protecting a support is characterized in that said support is thermoformable or thermally drape-formable and in that said step b) of curing is followed by:

c) shaping the varnished support by thermoforming or thermal drape forming.

Advantageously, said process for protecting a support is carried out with a preferably thermoformable or thermally drape-formable support at temperatures that are compatible with the varnish according to the invention covering the surface of the support, that is to say at temperatures that do not lead to the partial or total decomposition of the protective varnish according to the invention.

Advantageously, said process for protecting a support is carried out with a preferably thermoformable or thermally drape-formable support chosen from plastics and preferably from polycarbonates or polymethacrylates, in particular polymethyl methacrylate.

According to another aspect, the invention relates to the use of a crosslinkable composition according to any one of the variants described in the present document for protecting an optionally thermoformable or thermally drape-formable support from scratches and abrasion. Advantageously, said support is thermoformable or thermally drape-formable and consists of a glazing panel. Advantageously, said support is made of plastic, preferably polycarbonate or polymethacrylate, in particular polymethyl methacrylate.

According to another aspect, the invention relates to the use of a crosslinkable composition according to any one of the variants described in the present document for preparing scratch-resistant and abrasion-resistant thermoformable varnish.

According to another aspect, the invention relates to a scratch-resistant and abrasion-resistant thermoformable varnish able to be obtained by a process according to any one of the variants described in the present document.

According to another aspect, the invention relates to a scratch-resistant and abrasion-resistant (crosslinked) varnished article able to be obtained by a process according to any one of the variants described in the present document. Preferably, said varnished article is thermoformable or thermally drape-formable.

Advantageously, the support may be a plastic sheet, preferably a polycarbonate or polymethacrylate, in particular polymethyl methacrylate, sheet.

According to another aspect, the invention relates to an article able to be obtained by a process according to the invention, in any one of the variants described in the present document. Preferably, the article is thermoformable or thermally drape-formable.

According to another aspect, the invention relates to a scratch-resistant and abrasion-resistant thermoformable varnish, characterized in that it results from the crosslinking, under the action of UV-visible radiation, of at least one crosslinkable composition according to any one of the variants described in the present document.

The present invention affords numerous advantages, especially:
the coating/varnish obtained has excellent adhesion to plastic substrates
the varnish composition according to the invention may be produced inexpensively, since all the components thereof are commercially available
the coating/varnish obtained according to the invention with crosslinkable varnish compositions according to the invention has scratch resistance at high loading forces
the coating/varnish obtained according to the present invention does not crack, even when it is folded under hot conditions. It is particularly well-suited to protecting thermoformable or thermally drape-formable materials
the coating/varnish according to the invention may be obtained by a step of hardening by UV drying at room temperature in a single step without affecting its capacity for being shaped
in addition, the coating/varnish according to the invention may be used without solvent
the process according to the invention relies on photopolymerization, which is an excellent alternative to conventional thermal processes, is environmentally friendly and is attractive from an industrial perspective.

Other advantages may also become apparent to those skilled in the art on reading the examples below, with reference to the appended figures, given by way of non-limiting illustration.

### EQUIVALENTS

The following representative examples are intended to illustrate the invention and are not intended to limit the scope of the invention, nor should they be interpreted in this way. Indeed, various variants of the invention and of numerous other embodiments thereof, in addition to those presented and described here, will become apparent to those skilled in the art from the whole of the contents of this document, including the following examples.

The following examples contain important additional information, exemplification and teaching which may be suitable for practising this invention in its various embodiments and the equivalents thereof.

The following examples are given by way of indication and with no limiting character for the invention.

Advantages other than those described in the present application may become apparent to those skilled in the art on reading the examples below, given by way of illustration.

### BRIEF DESCRIPTION OF THE FIGURES

FIG. 1: A) Diagram of the motorized applicator fitted with a set of bars for the deposition of varnish films applied on PMMA sheets, used in examples 1 to 6. B) UV-visible conveyor for crosslinking the varnish.

FIG. 2: Code for classifying coating adhesion results according to standard ASTM D 3559.

FIG. 3: Comparative scratch resistance tests between the 3 varnishes of example 2, and 2 commercial varnishes. A). Depth of the scratch (μm). B) Force (N) at which (i) the first damage and (ii) the ruining of the sample are observed.

FIG. 4: Scratch resistance tests of the 4 varnishes of example 3: Force (N) at which (i) the first damage and (ii) the ruining of the sample are observed.

FIG. 5: Scratch resistance tests of the 4 varnishes of example 4: Force (N) at which (i) the first damage and (ii) the ruining of the sample are observed.

FIG. 6: Comparative scratch resistance tests of the varnishes b and e of example 4. A). Depth of the scratch (μm). B) Force (N) at which (i) the first damage and (ii) the ruining of the sample are observed.

FIG. 7: Scratch resistance tests of the 4 varnishes of example 5. A). Depth of the scratch (μm). B) Force (N) at which (i) the first damage and (ii) the ruining of the sample are observed.

FIG. 8: Thermoforming/thermal drape forming test of sample 280415A from example 6.

FIG. 9: Comparative adhesion tests of several varnish compositions according to the invention, by the crosscut test according to standard D3359.

Table 1: Different data obtained following scratching by a durometer. The images corresponding to the 1st damage and to the ruining are obtained by reflected light microscopy. The depth of penetration of the tip was determined by optical profilometry. The width of the deformation is calculated by the Gwyddion software.

### EXAMPLES

### Example 1—Application of Varnish and Scratch Resistance and Adhesion Properties—General Protocol

The preparation of the crosslinked varnished according to the process of the invention was carried out under the following experimental conditions:
The homogeneous liquid formulations were deposited by a motorized applicator on PMMA “ShieldUp®” sheets (Arkema). A set of calibrated bars was used in order to control the thickness of the films (cf. FIG. 1A).
The polymerization of the film of varnish composition deposited on the surface of the PMMA sheets was carried out at room temperature, without the addition of solvent, using a UV Qurtech industrial-grade conveyor after three to four passes (cf. FIG. 1B). The source of UV irradiation is an H microwave lamp. The lamp was used at 100% of its intensity. Each sample received 1.34 J/cm² during one pass.

The crosslinked varnish films were then tested for their scratch resistance.

The thickness of the films is measured by contactless optical profilometry. For this purpose, an Altisurf 500 (Altimet) measuring apparatus fitted with an Altiprobe Optic sensor (350 μm probe working at 5 mm from the surface) was used. The sensor is moved so as to scan a segment of a few centimeters (Z=f(X) profile measurement or profilometry).

With the aim of rapidly obtaining characterization of the scratch so as to validate or invalidate a formulation, scratch tests were carried out by a motorized CLEMEN durometer fitted with a spherical diamond-tipped cone (R=100 μm). The latter is brought into contact with the surface of the sample and moved in a straight line. The force exerted by the tool on the coating surface can be adjusted by means of a mobile weight of 0 to 1500 g, i.e. from 0 to 15 N. The PMMA samples are 2.5 cm×7.5 cm or 7.5 cm×8 cm and 4 mm thick.

By virtue of the characterizations by the durometer, it is possible to obtain the normal force that induces the first damage, the ruining of the film, and the width and depth of the deformation at a given pressure (table 1).

The adhesion of the varnish films to the substrate may also be tested according to the “cross-cut” test of standard ASTM D 3359. Briefly, the standardized procedure consists in producing a series of scratches spaced apart by approximately 1 mm (for films of thickness≤50 μm) and of a length of approximately 20 mm. Once the series of scratches has been completed, the surface of the substrate is very lightly brushed with a soft brush to eliminate any fragments of film which might have become detached. The procedure is repeated, this time producing a series of parallel scratches perpendicular to the first series, so as to obtain a grid of scratches. After eliminating any debris/fragments of coating from the surface of the substrate with the soft brush, a piece of adhesive tape is applied to the center of the grid of scratches (adhesive side in contact with the varnish coating). Ensure good contact between the adhesive tape and the surface of the substrate, if necessary by pressing the tape firmly using an eraser. After 90±30 s of application, remove the adhesive tape by grasping one end and by pulling it rapidly while maintaining an angle as close to 180° as possible. Inspect the region of the grid of scratches and evaluate the adhesion of the varnish using the classification provided for this purpose (cf. FIG. 2).

For the varnish films according to the invention, the procedure for measuring adhesion was slightly modified as follows: a special cut by a large handle, producing two series of perpendicularly-crossed lines in the form of crosshatching is made over ¾ of the surface of the film. A 3M scotch tape (2.5 N/m) standardized according to the cross-cut test is applied and removed, the cutting region is then evaluated to determine the adhesion. The scotch tape was used twice for each sample. The adhesion of the films to the PMMA ShieldUp is measured 12 hours after polymerization by a cross-cut test according to standard ASTM D 3359. A standardized 3M scotch tape (2.5 N/m) was used. The comparative results for several samples of different composition are given in FIG. 9 (samples A1 to G1).

| Films | SR238 ® | CN981 ® | CN9276 ® | I184 ® | I250 ® | BYK3505 | TCDDA | MAPTMS |
|---|---|---|---|---|---|---|---|---|
| A1 | 51.4 | 39.5 | — | 5.0 | — | 4.0 | — | — |
| B1 | 45.8 | 35.2 | — | 5.0 | — | 4.0 | 10.0 | — |
| C1 | 30.8 | 23.7 | — | 5.0 | — | 4.0 | 36.6 | — |
| D1 | 30.5 | 23.4 | — | 5.0 | 7.0 | 4.0 | — | 30.0 |
| E1 | 51.4 | — | 39.6 | 5.0 | — | 4.0 | — | — |
| F1 | 45.8 | — | 35.2 | 5.0 | — | 4.0 | 10.0 | — |
| G1 | 30.7 | — | 23.6 | 5.0 | — | 4.0 | 36.7 | — |

### Example 2—Comparative Study with Commercial Varnishes

Three different varnishes were produced, all using the diacrylate monomer reactive diluent SR238®:
a purely organic-based varnish “A2”
a purely organic-based varnish “B2” with the addition of a second diacrylate monomer reactive diluent
a hybrid-based varnish “C2” with the addition of a hybrid reactive diluent

The compositions of each of these varnishes are as follows (the values are expressed as % by weight relative to the total weight of the composition):

| Films | SR238 ® | CN981 ® | I184 ® | I250 ® | BYK3505 | TCDDA | MAPTMS |
|---|---|---|---|---|---|---|---|
| A2 | 51.4 | 39.5 | 5.0 | — | 4.0 | — | — |
| B2 | 30.8 | 23.7 | 5.0 | — | 4.0 | 36.6 | — |
| C2 | 30.5 | 23.4 | 5.0 | 7.0 | 4.0 | — | 30.0 |

The reactive diluent/oligomer (SR238/CN981) weight ratio was 1.3.

The different varnishes were applied with the calibrated bar, each one on a ShieldUp® (Arkema) PMMA sheet, and were polymerized under UV in a single step at room temperature (25° C.) without addition of solvent. The thickness of the liquid film is 10 μm+−1 μm, evaluated by contactless optical profilometry. The measurement of the thickness is important insofar as the behavior of the varnish film depends heavily thereon.

The scratch resistance of the varnish films obtained was tested using a Clemen Elcometer 3000 durometer, and was compared to that of two commercial varnishes: CETELON® and MOMENTIVE®, which are varnishes for application to transparent plastic parts, which are not thermoformable and can only be applied once the part has been thermoformed. The Cetelon® varnish is based on nanosilica+organic acrylic network, crosslinked under UV. The Momentive® varnish is based on an inorganic silicone network, thermally crosslinked. The results are presented in FIG. 3.

It can be seen that the 3 varnishes according to the invention have better performance in terms of scratch resistance than the 2 commercial varnishes. Indeed, the first damage for the 2 commercial samples is observed earlier (at a lower force) than for the varnishes according to the invention. The depth of the scratch is also greater for the commercial varnishes than for the varnishes of the invention.

In addition, it is observed that compared to the varnish “A2”, which only contains a single reactive diluent (SR238®), the addition of a second, reactive diluent, either organic (TCDDA) or hybrid (MAPTMS), improves the scratch resistance properties of the varnishes obtained in this way. For example, at F_{N}=4 N (maximum force reached), “B2” shows greater scratch resistance and shallower penetration of the ball (4 μm).

Comparative thermoforming/thermal drape forming tests were carried out: the 3 varnishes according to the invention are thermoformable (no cracking for a high deformation stress), while the 2 commercial varnishes are not thermoformable.

The other drawback of the 2 commercial varnishes is that they must be used with a solvent (70% by weight), whereas no solvent was used for the application and polymerization of the 3 varnishes according to the invention.

### Example 3—Purely Organic-Based Varnish Compositions—Addition of a Second Reactive Diluent

Four different varnishes were produced, all using the diacrylate monomer reactive diluent SR238® and a surface agent (BYK302®).

The compositions of each of these varnishes are as follows (unless indicated otherwise, the values are expressed as % by weight relative to the total weight of the composition):

| | | | | | | Thickness |
|---|---|---|---|---|---|---|
| Films | SR238 ® | CN9276 ® | I184 ® | BYK302 | TCDDA | (μm) |
| A3 | 59.2 | 35.0 | 5.0 | 0.8 | — | 9.5 |
| B3 | 53.13 | 31.07 | 5.0 | 0.8 | 10.0 | 10.0 |
| C3 | 46.82 | 27.38 | 5.0 | 0.8 | 20.0 | 11.0 |
| D3 | 42.9 | 21.3 | 5.0 | 0.8 | 30.0 | 11.0 |

The reactive diluent/oligomer (SR238/CN9276) weight ratio was 1.7.

The different varnishes were applied with the calibrated bar, each one on a ShieldUp® (Arkema) PMMA sheet, and were polymerized under UV in a single step at room temperature (25° C.) without addition of solvent.

The scratch resistance of the varnish films obtained was tested using a Clemen Electometer 3000 durometer. The results are presented in FIG. 4.

### Example 4—Purely Organic-Based Varnish Compositions—Different Reactive Diluent/Oligomer Weight Ratios

Five different varnishes were produced, all using the diacrylate monomer reactive diluent SR238® and the urethane acrylate oligomer CN9276®.

The compositions of each of these varnishes are as follows (unless indicated otherwise, the values are expressed as % by weight relative to the total weight of the composition):

| | | | | | | SR238/ |
|---|---|---|---|---|---|---|
| | | | | | | CN9276 |
| | | | | | | weight |
| Films | SR238 ® | CN9276 ® | I184 ® | BYK302 | BYK3505 | ratio |
| A4 | 53.2 | 41 | 5 | 0.8 | — | 1.3 |
| B4 | 53.2 | 41 | 5 | — | 0.8 | 1.32 |
| C4 | 59.2 | 35 | 5 | 0.8 | — | 1.71 |
| D4 | 59.2 | 35 | 5 | — | 0.8 | 1.71 |
| E4 | 51.4 | 39.5 | 5 | 4.0 | — | 1.32 |

The different varnishes were applied with the calibrated bar, each one on a ShieldUp® (Arkema) PMMA sheet, and were polymerized under UV in a single step at room temperature (25° C.) without addition of solvent.

The scratch resistance of the varnish films obtained was tested using a Clemen Elcometer 3000 durometer. The results for the formulations a to d are presented in FIG. 5. The comparative results between formulations b and e are presented in FIG. 6.

In both the weight ratio cases studied (SR238/CN9276=1.3 or 1.7), the addition of a surface agent made it possible to improve the scratch behavior of the crosslinked varnish.

The increase in the concentration of surface agent from 0.8 to 4.0% by weight results in an even more scratch-resistant varnish (shallower penetration of the tip of the durometer for the varnish containing 4.0% of BYK3505).

### Example 5—Purely Organic-Based Varnish Compositions—Addition of a Second Reactive Diluent

Four different varnishes were produced.

The compositions of each of these varnishes are as follows (unless indicated otherwise, the values are expressed as % by weight relative to the total weight of the composition):

| Films | SR238 ® | CN9276 ® | CN981 ® | I184 ® | BYK3505 | TCDDA | Thickness |
|---|---|---|---|---|---|---|---|
| A5 | 51.4 | 0 | 39.5 | 5.0 | 4.0 | 0 | 10 μm |
| B5 | 45.8 | 0 | 35.2 | 5.0 | 4.0 | 10.0 | 10 μm |
| C5 | 51.4 | 39.5 | 0 | 5.0 | 4.0 | 0 | 10 μm |
| D5 | 45.8 | 35.2 | 0 | 5.0 | 4.0 | 10.0 | 11 μm |

The reactive diluent/oligomer (SR238/CN9276 or SR238/CN981) weight ratio was 1.3.

The different varnishes were applied with the calibrated bar, each one on a ShieldUp® (Arkema) PMMA sheet, and were polymerized under UV in a single step at room temperature (25° C.) without addition of solvent.

The scratch resistance of the varnish films obtained was tested using a Clemen Elcometer 3000 durometer. The results are presented in FIG. 7.

In both the weight ratio cases studied (SR238/CN9276=1.3 or 1.7), the addition of a surface agent made it possible to improve the scratch behavior of the crosslinked varnish.

The increase in the concentration of surface agent from 0.8 to 4.0% by weight results in a more scratch-resistant varnish (shallower penetration of the tip of the durometer for the varnish containing 4.0% of BYK302).

### Example 6—Thermoforming/Thermal Drape-Forming

There are several possible methods of thermoforming

### 1) Drape Forming

(i) the sheet (PC or PMMA) is placed in an oven to soften the plastic. For the PC, ˜5 min at 200° C.
(ii) the sheet is “manually” moved over a mold. The sheet begins to deform by gravity.
(iii) a countermold is placed on the hot sheet and gives the definitive shape to the part. Cooling for 3 min before removing from the mold.

### 2) Compression Molding

The sheet is heated and directly shaped in a press. This process is reserved for the most complex geometries that require greater elongation of the plastic.

### 3) Relaxation

This is forming by gravity in an oven. The advantage of this process is to remove a stress maximum (plastic memory) from the part, but it is carried out on very small series (long cycle time).

In the present example, the thermoforming tests were carried out by the “2D” drape-forming process on PMMA substrates coated with a varnish according to the present invention.

Substrates: PMMA Shieldup (Arkema), 5 mm thick, dimensions 300×300 mm, coated with varnish 280415A 16, 18 and 19 μm thick.

The composition of this varnish is detailed in the table below (unless indicated otherwise, the figures are expressed as % by weight relative to the total weight of the composition):

| Film | SR238 ® | CN981 ® | I184 ® | BYK3505 | TCDDA |
|---|---|---|---|---|---|
| 280415A | 30.7 | 23.6 | 5.0 | 4.0 | 36.7 |

The reactive diluent/oligomer (SR238/CN981) weight ratio was 1.3.

### Tested on:

Mold 1: “2D light”: Four Sat—Fritzmeier 524017 mold

Mold 2: “2D strong” Strada light guide

Thermoforming conditions for all tests carried out: “2D” drape-forming process (cf. detail of the process above). Placing in oven at 140° C. for 10 min before thermoforming.

Results: the samples were successfully thermoformed without any cracking of the varnish, as illustrated in FIG. 8.

### REFERENCE LIST

1. EP 0 035 272
2. Belon et al., Macromol. Mater. Eng., 2011, 296(6), 506-516
3. Belon et al., J. polym. Sci.: Part A: Polymer Chemistry, 2010, 48(19), 4150-4158
4. WO 2013/171582
5. WO 94/22968
6. EP 0 276 501
7. EP0 249 201
8. WO 97/12945
9. EP 0 008 127

1. A varnish composition, crosslinkable under the action of UV-visible radiation, comprising:
A) at least one multifunctional urethane acrylate oligomer comprising 2 to 9 acrylate functions, which is the product of the reaction of a diisocyanate or triisocyanate with a hydroxylated acrylate monomer, preferably with a stoichiometric excess of a hydroxylated acrylate monomer, said hydroxylated acrylate monomer being a random mixture resulting from the reaction of a polyol with a stoichiometric deficiency of acrylic acid, with the proviso that the chain of the diisocyanate or triisocyanate has not been extended beforehand by a polyol, polyester, polyether or polycarbonate comprising residual hydroxyl functions;
B) at least one reactive diluent selected from acrylate monomers; and
C) at least one photoinitiator suitable for the light source used for the crosslinking;
D) optionally at least one surface agent; and
E) optionally at least one stabilizing anti-UV agent.

2. The composition as claimed in claim 1, wherein said at least one multifunctional urethane acrylate oligomer comprising 2 to 9 acrylate functions corresponds to the following formula I^{A} or I^{B}: [chemical structure]
in which:
R₁ represents a C1 to C10 aliphatic, mono- or bicyclic C5 to C8 alicyclic or C6 to C13 aromatic radical, preferably C1 to C10 aliphatic or C5 to C8 alicyclic radical optionally substituted with one or more C1-C6 alkyl radicals;
R₂ independently represents a linear, branched or cyclic C1-C10 alkyl group, the C1-C10 alkyl chain being able to be optionally interrupted by an ester (—C(═O)O—) or ether (—O—)-function; and
each instance of n independently represents a mean number of acrylate functions of between 1 and 4, preferably between 1 and 3, preferably between 1 and 2, preferably 1 for the formula I^{A}, and between 1 and 3; preferably between 1 and 2, preferably 1 for the formula I^{B}.

3. The composition as claimed in claim 1, wherein said at least one reactive diluent is selected from diacrylate monomers.

4. The composition as claimed in claim 1, wherein said at least one reactive diluent is a mixture of two acrylate monomers selected from mono-, di-, tetra- or hexacrylate monomers, preferably aliphatic or alicyclic, most preferentially a mixture of two diacrylate monomers, preferably aliphatic or alicyclic.

5. The composition as claimed in claim 1, wherein the multifunctional oligomer is an aliphatic urethane diacrylate, tetracrylate, or hexacrylate, preferably an aliphatic urethane diacrylate.

6. The composition as claimed in claim 1, wherein the multifunctional oligomer is a multifunctional aliphatic urethane acrylate oligomer comprising 6 to 9 acrylate functions.

7. The composition as claimed in claim 1, also comprising a hybrid organic-inorganic reactive diluent that may react by photopolymerization and photosol-gel reaction, of formula
R⁴₍₄₋ₘ₎—Si—(R⁵)ₘ,
in which
m represents an integer between 1 and 3;
each instance of R⁴ independently represents a non-hydrolyzable group covalently bonded to Si via a carbon atom, it being understood that at least one instance of R⁴ comprises an unsaturated photopolymerizable group; and
each instance of R⁵ independently represents a hydrolyzable group selected from C1-C6 alkoxy, C1-C6 acyloxy, a halogen atom or an amino group; preferably C1-C6 alkoxy such as methoxy or ethoxy, preferably methoxy.

8. The composition as claimed in claim 1, comprising at least two acrylate, preferably diacrylate, monomer reactive diluents, in which the reactive diluents/multifunctional oligomer weight ratio is between 1.5 and 3.5, preferably between 1.5 and 3.0, the ratio being calculated taking into consideration the sum by weight of the acrylate monomers.

9. The composition as claimed in claim 1, comprising a diacrylate monomer as reactive diluent, in which the diacrylate monomer/multifunctional oligomer weight ratio is between 1.3 and 1.7.

10. The composition as claimed in claim 1, wherein the photoinitiator is chosen from:
type I radical photoinitiators
of the family of the acetophenones, alkoxyacetophenones and derivatives such as 2,2-dimethoxy-2-phenylacetophenone and 2,2-diethyl-2-phenylacetophenone;
of the family of the hydroxyacetophenones and derivatives such as 2,2-dimethyl-2-hydroxyacetophenone, 1-hydroxycyclohexylphenyl ketone, 2-hydroxy-4′-(2-hydroxyethoxy)-2-methylpropiophenone and 2-hydroxy-4′-(2-hydroxypropoxy)-2-methylpropiophenone;
of the family of alkylaminoacetophenones and derivatives such as 2-methyl-4′-(methylthio)-2-morpholinopropiophenone, 2-benzyl-2-(dimethylamino)-4-morpholinobutyrophenone and 2-(4-(methylbenzyl)-2-(dimethylamino)-4-morpholinobutyrophenone;
of the family of benzoin ethers and derivatives such as benzyl, benzoin methyl ether and benzoin isopropyl ether;
of the family of phosphine oxides and derivatives such as diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
type II radical photoinitiators
of the family of benzophenones and derivatives such as 4-phenylbenzophenone, 4-(4′-methylphenylthio)benzophenone, 1-[4-[(4-benzoylphenyl)thio]phenyl]-2-methyl-2-[(4-methylphenyl) sulfonyl]-1-propanone;
the family of thioxanthones and derivatives such as isopropylthioxanthone (ITX), 2,4-diethylthioxanthone, 2,4-dimethylthioxanthone, 2-chlorothioxanthone and 1-chloro-4-isopropylthioxanthone;
the family of quinones and derivatives such as anthraquinones including 2-ethylanthraquinone and camphorquinones;
the family of esters of benzoyl formate and derivatives such as methyl benzoylformate; the family of metallocenes and derivatives such as ferrocene, titanium bis(eta 5-2,4-cyclopentadien-1-yl)bis(2,6-difluoro)-3-(1H-pyrrol-1-yl)phenyl) and (cumene)cyclopentadienyl iron hexafluorophosphate;
the family of dibenzylidene ketones and derivatives such as p-dimethylaminoketone;
the family of coumarins and derivatives such as 5-methoxy and 7-methoxy coumarin, 7-diethylamino coumarin and N-phenylglycine coumarin;
photoinitiators of the family of dyes such as triazines and derivatives, fluorones and derivatives, cyanins and derivatives, safranins and derivatives, 4,5,6,7-tetrachloro-3′,6′-dihydroxy-2′,4′,5′,7′-tetraiodo-3H-spiro[isobenzofuran-1,9′-xanthen]-3-one, pyrylium and thiopyrylium and derivatives, thiazines and derivatives, flavins and derivatives, pyronines and derivatives, oxazines and derivatives, rhodamines and derivatives;
a mixture of at least two of the abovementioned photoinitiators.

11. The composition as claimed in claim 10, wherein, when the composition also contains a hybrid organic-inorganic reactive diluent, said at least one photoinitiator also contains at least one cationic photoinitiator selected from onium salts, organometallic complexes and non-ionic photoacids, wherein the hybrid organic-inorganic reactive diluent may react by photopolymerization and photosol-gel reaction and corresponds to formula
R⁴₍₄₋ₘ₎—Si—(R⁵)ₘ,
in which
m represents an integer between 1 and 3;
each instance of R⁴ independently represents a non-hydrolyzable group covalently bonded to Si via a carbon atom, it being understood that at least one instance of R⁴ comprises an unsaturated photopolymerizable group; and
each instance of R⁵ independently represents a hydrolyzable group selected from C1-C6 alkoxy, C1-C6 acyloxy, a halogen atom or an amino group; preferably C1-C6 alkoxy such as methoxy or ethoxy, preferably methoxy.

12. The composition as claimed in claim 1, wherein the surface agent is a silicone-based or acrylic copolymer-based surface agent.

13. The composition as claimed in claim 1, also comprising at least one UV stabilizer selected from UV absorbers and sterically hindered amines.

14. The composition as claimed in claim 1, which composition is crosslinkable in the absence of solvent.

15. The composition as claimed in claim 1, characterized in that it comprises:
(i)
A) 30 to 50% by weight, preferably 35 to 45% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN981®;
B) an aliphatic diacrylate monomer such as SR238®, as reactive diluent, at an amount of 40 to 60%, preferably 45 to 55% by weight;
C) 1 to 10%, preferably 3 to 7% by weight of a radical photoinitiator as defined in claim 10; preferably a type I radical photoinitiator, most preferentially 1-hydroxycyclohexylphenyl ketone (Irgacure 184®);
D) optionally 1 to 10% by weight of a surface agent; and
E) optionally 1 to 10% by weight of a UV stabilizer;
the sum of the percentages of all the components being equal to 100% of the total weight of the composition subjected to crosslinking; and
wherein the diacrylate monomer/multifunctional oligomer weight ratio is between 1.3 and 1.7;
(ii)
A) 20 to 50% by weight, preferably 20 to 40% by weight, of an aliphatic urethane diacrylate (such as CN981®, CN9001® or CN991®), tetracrylate (such as CN9276®), or hexacrylate (such as CN9210® or EB1290) oligomer, preferably an aliphatic urethane diacrylate oligomer such as CN981®;
B) a mixture of two aliphatic or alicyclic diacrylate monomers, such as SR238® and SR833S®, as reactive diluents, at an amount of 50 to 70%, preferably 55 to 70% by weight;
C) 1 to 10%, preferably 3 to 7% by weight of a radical photoinitiator as defined in claim 10; preferably a type I radical photoinitiator, most preferentially 1-hydroxycyclohexylphenyl ketone (Irgacure 184®);
D) optionally 1 to 10% by weight of a surface agent; and
E) optionally 1 to 10% by weight of a UV stabilizer;
the sum of the percentages of all the components being equal to 100% of the total weight of the composition subjected to crosslinking;
wherein the diacrylate monomers/multifunctional oligomer weight ratio is between 1.5 and 3.5, preferably between 1.5 and 3.0; the sum by weight of the two reactive diluents being taken into consideration for calculating this ratio; and
the acyclic aliphatic diacrylate monomer (such as SR238®) and the alicyclic diacrylate monomer (such as SR833S®) are present in a weight ratio of 40/60 to 90/10, preferably 45/55 to 85/15;
or (iii)
A) 45 to 65%, preferably 50 to 60% by weight of an aliphatic urethane oligomer having a functionality of greater than or equal to 6; preferably an aliphatic urethane hexacrylate, octacrylate or nonacrylate oligomer;
B) 25 to 45%, preferably 30 to 40%, by weight of an aliphatic diacrylate monomer as reactive diluent;
C) 5 to 15%, preferably 5 to 7% by weight of a radical photoinitiator as defined in claim 10; preferably a type I radical photoinitiator;
D) optionally 1 to 10% by weight of a surface agent, preferably from the class of silicones; and
E) optionally 1 to 10% by weight of a UV stabilizer;
the sum of the percentages of all the components being equal to 100% of the total weight of the composition subjected to crosslinking.

16. A process for preparing a scratch-resistant and abrasion-resistant thermoformable varnish, said process comprising the formation of said varnish by crosslinking the composition of claim 1 under the action of UV-visible radiation.

17. The process as claimed in claim 16, wherein the source of UV or visible radiation is an LED or a discharge lamp.

18. (canceled)

19. A process for protecting a support from scratches and abrasion, said support preferably being thermoformable or thermally drape-formable, said process comprising the following successive steps:
a) coating a surface of an optionally thermoformable or thermally drape-formable support with a varnish composition as claimed in claim 1;
b) curing the varnish composition covering the coated surface of the support by crosslinking said composition under the action of UV-visible radiation; and
c) in the case in which said support is thermoformable or thermally drape-formable, optionally shaping the varnished support by thermoforming or thermal drape forming.

20.-23. (canceled)

24. A scratch-resistant and abrasion-resistant varnished article, which is preferably thermoformable or thermally drape-formable, able to be obtained by a process as claimed in claim 16.

25. (canceled)

26. A scratch-resistant and abrasion-resistant thermoformable varnish, characterized in that it results from the crosslinking, under the action of UV-visible radiation, of at least one composition as defined in claim 1.
